(19) United States
(12) Patent Application Publication
(10) Pub. No.: US 2023/0156606 A1
(43) Pub. Date: May 18, 2023

(54) TECHNIQUE FOR PERFORMING MULTI-LINK COMMUNICATION IN WIRELESS COMMUNICATION SYSTEM

(71) Applicant: LG ELECTRONICS INC., Seoul (KR)

(72) Inventors: Namyeong KIM, Seoul (KR); Jeongki KIM, Seoul (KR); Jinsoo CHOI, Seoul (KR); Sungjin PARK, Seoul (KR); Taewon SONG, Seoul (KR); Insun JANG, Seoul (KR)

(21) Appl. No.: 17/915,825

(22) PCT Filed: Apr. 2, 2021
(86) PCT No.: PCT/KR2021/004143

§ 371 Date: Sep. 29, 2022

(30) Foreign Application Priority Data
Apr. 2, 2020 (KR) 10-2020-0040505

(51) Int. Cl. H04W 52/02; H04W 74/08

(52) U.S. Cl. CPC H04W 52/0274; H04W 74/0816

(57) ABSTRACT

According to various embodiments, a multi-link device (MLD) comprising a first STA and a second STA may perform the steps of: receiving, from an access point (AP) via the first STA operating in a first link, network allocation vector (NAV) time information about the second STA operating in a second link, wherein, when the NAV time information about the second STA is received, the second STA operates in a doze state; identifying that the state of the second STA is changed from the doze state to an awake state; and setting an NAV time for the second STA, on the basis of the NAV time information about the second STA.

### BACKGROUND

### Technical Field

The present specification relates to a technique for performing multi-link communication in a WLAN system, and more particularly, to a method for transmitting link-related information in multi-link communication and an apparatus supporting the same.

### Related Art

A wireless local area network (WLAN) has been improved in various ways. For example, the IEEE 802.11ax standard proposed an improved communication environment using orthogonal frequency division multiple access (OFDMA) and downlink multi-user multiple input multiple output (DL MU MIMO) techniques.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

### SUMMARY

### Technical Objects

In the EHT standard, in order to support high throughput and high data rate, a wide bandwidth (for example, 160/320 MHz), 16 streams, and/or multi-link (or multi-band) operation may be used.

In the EHT standard, a device supporting multi-link (that is, multi-link device) may operate on a plurality of links. The multi-link device may operate in a power save mode (PSM). The multi-link device may include a first STA and a second STA. The first STA and the second STA may individually operate in a power save mode (PSM). At least one of the first STA and the second STA may operate in one of an awake state and a doze state.

### Technical Solutions

According to various embodiments, a multi-link device including a first station (STA) and a second STA in a wireless local area network system may perform steps of receiving, from an access point (AP) through the first STA operating in a first link, network allocation vector (NAV) interval information about the second STA operating in a second link, wherein, when the NAV interval information about the second STA is received, the second STA operates in a doze state; identifying that the state of the second STA is changed from the doze state to an awake state; and setting a NAV interval for the second STA, based on the NAV interval information about the second STA.

### Technical Effects

The STA included in a device may transmit information about another STA (or link) in the multi-link device together through one link. Accordingly, there is an effect that the overhead of frame exchange is reduced. In addition, there is an effect of increasing the link use efficiency of the STA and reducing power consumption.

In addition, the multi-link device may receive NAV information about the second link (or the second STA) through the first link. When the second STA operates in the doze state, it is not possible to determine whether the NAV (or NAV interval) needs to be set, so that NAV information can be received through the first STA. Accordingly, when the second STA changes from a doze state to an awake state, there is an effect that NAV (or NAV interval) can be set without probe delay.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 illustrates an example of a PPDU used in an IEEE standard.

FIG. 5 illustrates an operation based on UL-MU.

FIG. 6 illustrates an example of a trigger frame.

FIG. 7 illustrates an example of a common information field of a trigger frame.

FIG. 8 illustrates an example of a subfield included in a per user information field.

FIG. 9 illustrates an example of a channel used/supported/defined within a 2.4 GHz band.

FIG. 10 illustrates an example of a channel used/supported/defined within a 5 GHz band.

FIG. 11 illustrates an example of a channel used/supported/defined within a 6 GHz band.

FIG. 12 illustrates an example of a PPDU used in the present specification.

FIG. 13 illustrates an example of a modified transmission device and/or receiving device of the present specification.

FIG. 14 shows an example of channel bonding.

FIG. 15 shows an example in which a collision may occur in a non-STR MLD.

FIG. 16 shows another example in which a collision may occur in a non-STR MLD.

FIG. 17 shows the basic structures of an AP MLD and a non-AP MLD.

FIG. 18 shows an example of a section in which a link is not used in a non-AP MLD.

FIG. 19 shows another example of a section in which a link is not used in a non-AP MLD.

FIG. 20 shows an example of the operation of a non-AP MLD and an AP MLD.

FIG. 21 shows another example of the operation of a non-AP MLD and an AP MLD.

FIG. 22 show another example of the operations of a non-AP MLD and an AP MLD.

FIG. 23 shows another example of the operation of a non-AP MLD and an AP MLD.

FIG. 24 shows another example of the operation of a non-AP MLD and an AP MLD.

FIG. 25 shows another example of the operations of a non-AP MLD and an AP MLD.

FIG. 26 shows another example of the operation of a non-AP MLD and an AP MLD.

FIG. 27 shows another example of the operations of a non-AP MLD and an AP MLD.

FIG. 28 shows another example of the operation of a non-AP MLD and an AP MLD.

FIG. 29 shows another example of the operation of a non-AP MLD and an AP MLD.

FIG. 30 shows another example of the operations of a non-AP MLD and an AP MLD.

FIG. 31 shows another example of the operation of a non-AP MLD and an AP MLD.

FIG. 32 shows another example of the operation of a non-AP MLD and an AP MLD.

FIG. 33 shows another example of the operation of a non-AP MLD and an AP MLD.

FIG. 34 shows another example of the operation of a non-AP MLD and an AP MLD.

FIG. 35 shows another example of the operation of a non-AP MLD and an AP MLD.

FIG. 36 shows another example of the operation of a non-AP MLD and an AP MLD.

FIG. 37 shows another example of the operation of a non-AP MLD and an AP MLD.

FIG. 38 is a flowchart for explaining the operation of a multi-link device.

FIG. 39 is a flowchart for explaining the operation of an AP multi-link device.

### DETAILED DESCRIPTION

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may denote that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3^{rd} generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

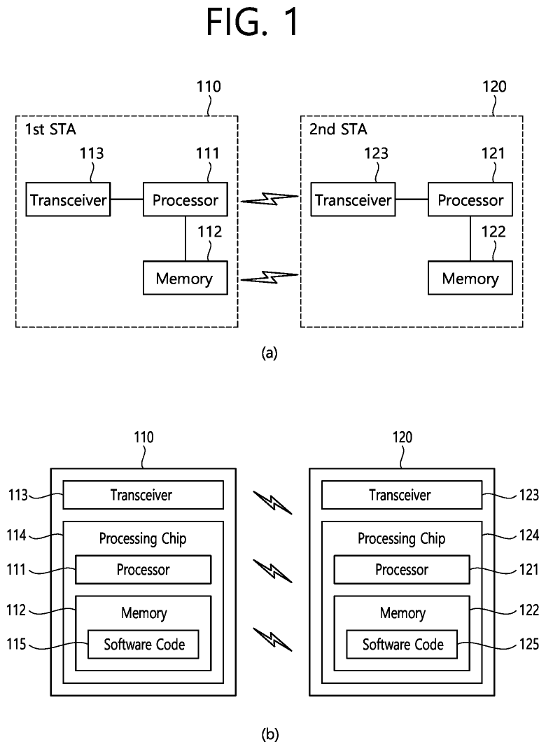

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, a STA1, a STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

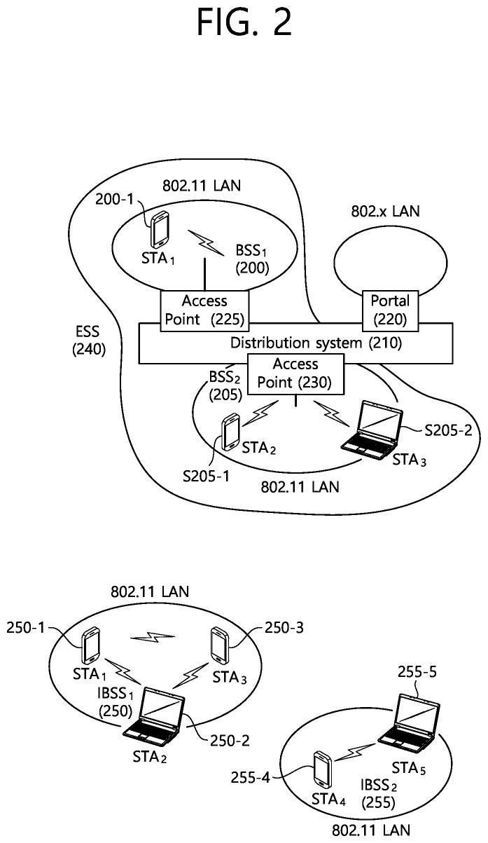

FIG. 2 is a conceptual view illustrating the structure of a wireless local area network (WLAN).

An upper part of FIG. 2 illustrates the structure of an infrastructure basic service set (BSS) of institute of electrical and electronic engineers (i.e. EE) 802.11.

Referring the upper part of FIG. 2, the wireless LAN system may include one or more infrastructure BSSs 200 and 205 (hereinafter, referred to as BSS). The BSSs 200 and 205 as a set of an AP and a STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (i.e. EE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

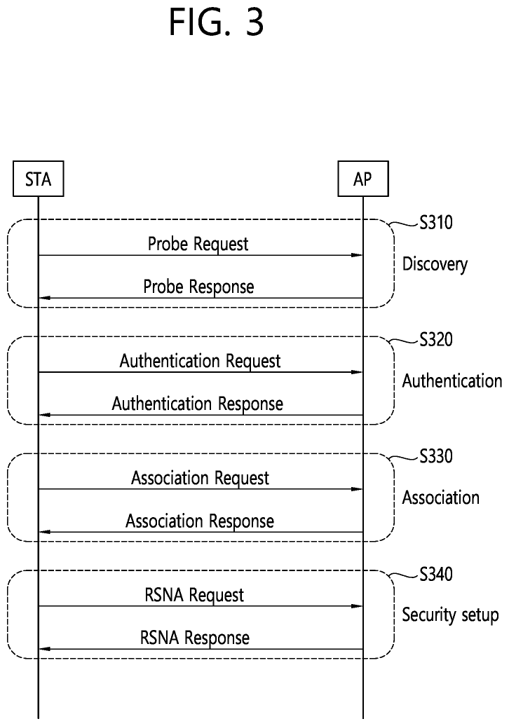

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information related to a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinct from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information related to an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information related to various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information related to various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

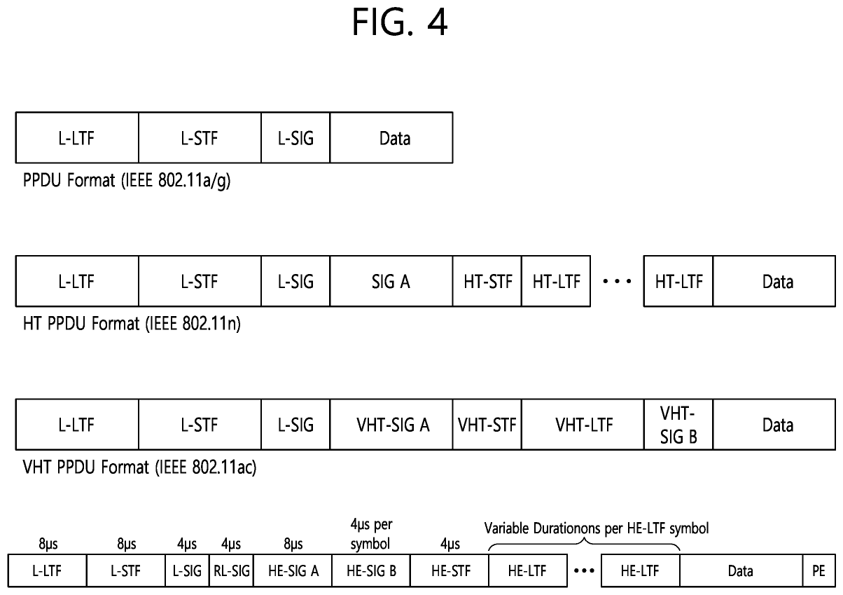

FIG. 4 illustrates an example of a PPDU used in an IEEE standard.

As illustrated, various types of PHY protocol data units (PPDUs) are used in IEEE a/g/n/ac standards. Specifically, an LTF and a STF include a training signal, a SIG-A and a SIG-B include control information for a receiving STA, and a data field includes user data corresponding to a PSDU (MAC PDU/aggregated MAC PDU).

FIG. 4 also includes an example of an HE PPDU according to IEEE 802.11ax. The HE PPDU according to FIG. 4 is an illustrative PPDU for multiple users. An HE-SIG-B may be included only in a PPDU for multiple users, and an HE-SIG-B may be omitted in a PPDU for a single user.

As illustrated in FIG. 4, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted for illustrated time periods (i.e., 4 or 8 μs).

Hereinafter, a resource unit (RU) used for a PPDU is described. An RU may include a plurality of subcarriers (or tones). An RU may be used to transmit a signal to a plurality of STAs according to OFDMA. Further, an RU may also be defined to transmit a signal to one STA. An RU may be used for an STF, an LTF, a data field, or the like.

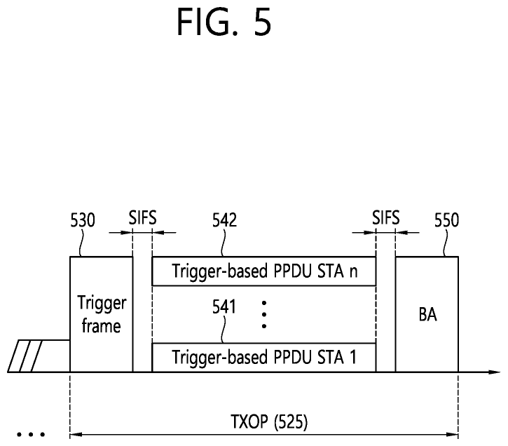

FIG. 5 illustrates an operation based on UL-MU. As illustrated, a transmitting STA (e.g., an AP) may perform channel access through contending (e.g., a backoff operation), and may transmit a trigger frame 530. That is, the transmitting STA may transmit a PPDU including the trigger frame 530. Upon receiving the PPDU including the trigger frame, a trigger-based (TB) PPDU is transmitted after a delay corresponding to SIFS.

TB PPDUs 541 and 542 may be transmitted at the same time period, and may be transmitted from a plurality of STAs (e.g., user STAs) having AIDs indicated in the trigger frame 530. An ACK frame 550 for the TB PPDU may be implemented in various forms.

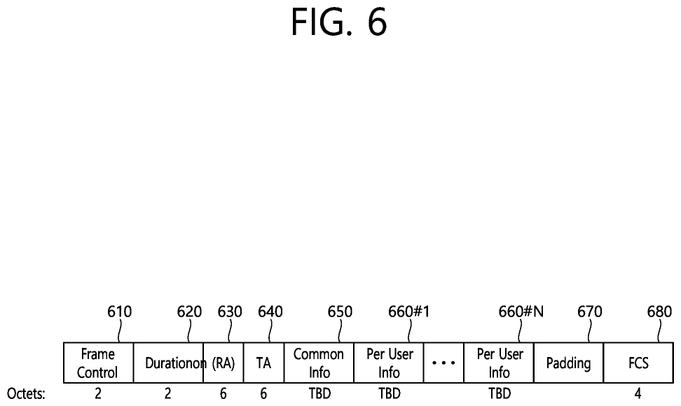

A specific feature of the trigger frame is described with reference to FIG. 6 to FIG. 8. Even if UL-MU communication is used, an orthogonal frequency division multiple access (OFDMA) scheme or a MU MIMO scheme may be used, and the OFDMA and MU-MIMO schemes may be simultaneously used.

FIG. 6 illustrates an example of a trigger frame. The trigger frame of FIG. 6 allocates a resource for uplink multiple-user (MU) transmission, and may be transmitted, for example, from an AP. The trigger frame may be configured of a MAC frame, and may be included in a PPDU.

Each field shown in FIG. 6 may be partially omitted, and another field may be added. In addition, a length of each field may be changed to be different from that shown in the figure.

A frame control field 610 of FIG. 6 may include information related to a MAC protocol version and extra additional control information. A duration field 620 may include time information for NAV configuration or information related to an identifier (e.g., AID) of a STA.

In addition, an RA field 630 may include address information of a receiving STA of a corresponding trigger frame, and may be optionally omitted. A TA field 640 may include address information of a STA (e.g., an AP) which transmits the corresponding trigger frame. A common information field 650 includes common control information applied to the receiving STA which receives the corresponding trigger frame. For example, a field indicating a length of an L-SIG field of an uplink PPDU transmitted in response to the corresponding trigger frame or information for controlling content of a SIG-A field (i.e., HE-SIG-A field) of the uplink PPDU transmitted in response to the corresponding trigger frame may be included. In addition, as common control information, information related to a length of a CP of the uplink PPDU transmitted in response to the corresponding trigger frame or information related to a length of an LTF field may be included.

In addition, per user information fields 660 #1 to 660 #N corresponding to the number of receiving STAs which receive the trigger frame of FIG. 6 are preferably included. The per user information field may also be called an “allocation field”.

In addition, the trigger frame of FIG. 6 may include a padding field 670 and a frame check sequence field 680.

Each of the per user information fields 660 #1 to 660 #N shown in FIG. 6 may include a plurality of subfields.

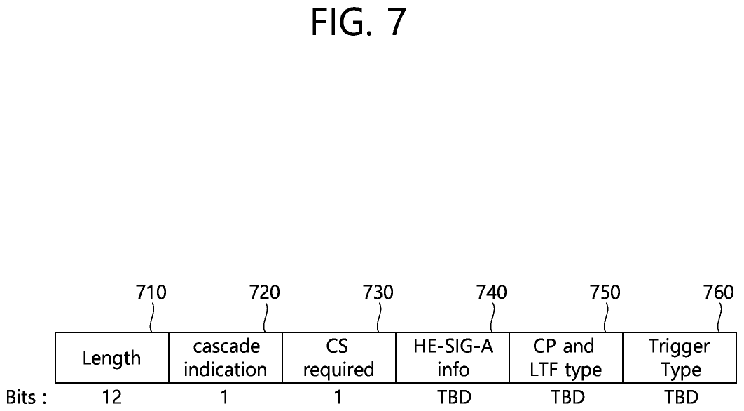

FIG. 7 illustrates an example of a common information field of a trigger frame. A subfield of FIG. 7 may be partially omitted, and an extra subfield may be added. In addition, a length of each subfield illustrated may be changed.

A length field 710 illustrated has the same value as a length field of an L-SIG field of an uplink PPDU transmitted in response to a corresponding trigger frame, and a length field of the L-SIG field of the uplink PPDU indicates a length of the uplink PPDU. As a result, the length field 710 of the trigger frame may be used to indicate the length of the corresponding uplink PPDU.

In addition, a cascade identifier field 720 indicates whether a cascade operation is performed. The cascade operation implies that downlink MU transmission and uplink MU transmission are performed together in the same TXOP. That is, it implies that downlink MU transmission is performed and thereafter uplink MU transmission is performed after a pre-set time (e.g., SIFS). During the cascade operation, only one transmitting device (e.g., AP) may perform downlink communication, and a plurality of transmitting devices (e.g., non-APs) may perform uplink communication.

A CS request field 730 indicates whether a wireless medium state or a NAV or the like is necessarily considered in a situation where a receiving device which has received a corresponding trigger frame transmits a corresponding uplink PPDU.

An HE-SIG-A information field 740 may include information for controlling content of a SIG-A field (i.e., HE-SIG-A field) of the uplink PPDU in response to the corresponding trigger frame.

A CP and LTF type field 750 may include information related to a CP length and LTF length of the uplink PPDU transmitted in response to the corresponding trigger frame. A trigger type field 760 may indicate a purpose of using the corresponding trigger frame, for example, typical triggering, triggering for beamforming, a request for block ACK/NACK, or the like.

It may be assumed that the trigger type field 760 of the trigger frame in the present specification indicates a trigger frame of a basic type for typical triggering. For example, the trigger frame of the basic type may be referred to as a basic trigger frame.

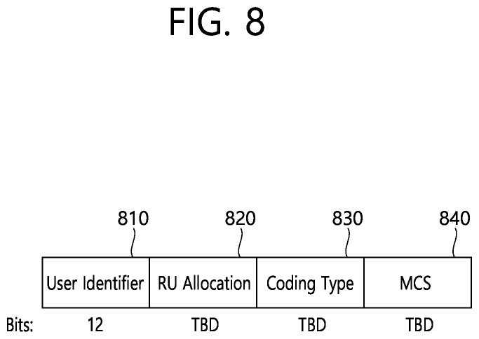

FIG. 8 illustrates an example of a subfield included in a per user information field. A user information field 800 of FIG. 8 may be understood as any one of the per user information fields 660 #1 to 660 #N mentioned above with reference to FIG. 6. A subfield included in the user information field 800 of FIG. 8 may be partially omitted, and an extra subfield may be added. In addition, a length of each subfield illustrated may be changed.

A user identifier field 810 of FIG. 8 indicates an identifier of a STA (i.e., receiving STA) corresponding to per user information. An example of the identifier may be the entirety or part of an association identifier (AID) value of the receiving STA.

In addition, an RU allocation field 820 may be included. That is, when the receiving STA identified through the user identifier field 810 transmits a TB PPDU in response to the trigger frame, the TB PPDU is transmitted through an RU indicated by the RU allocation field 820.

The subfield of FIG. 8 may include a coding type field 830. The coding type field 830 may indicate a coding type of the TB PPDU. For example, when BCC coding is applied to the TB PPDU, the coding type field 830 may be set to ‘1’, and when LDPC coding is applied, the coding type field 830 may be set to ‘0’.

In addition, the subfield of FIG. 8 may include an MCS field 840. The MCS field 840 may indicate an MCS scheme applied to the TB PPDU. For example, when BCC coding is applied to the TB PPDU, the coding type field 830 may be set to ‘1’, and when LDPC coding is applied, the coding type field 830 may be set to ‘0’.

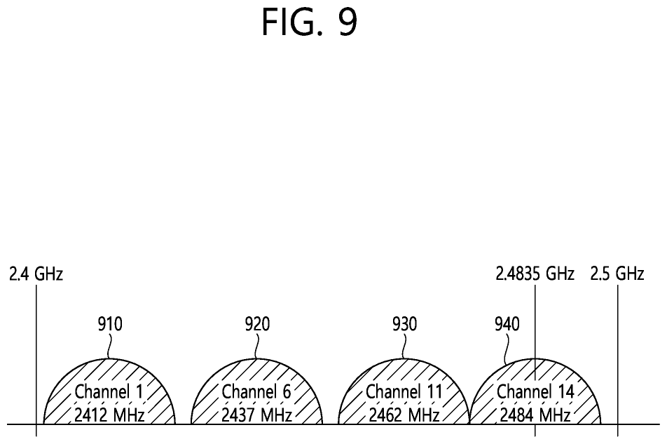

FIG. 9 illustrates an example of a channel used/supported/defined within a 2.4 GHz band.

The 2.4 GHz band may be called in other terms such as a first band. In addition, the 2.4 GHz band may imply a frequency domain in which channels of which a center frequency is close to 2.4 GHz (e.g., channels of which a center frequency is located within 2.4 to 2.5 GHz) are used/supported/defined.

A plurality of 20 MHz channels may be included in the 2.4 GHz band. 20 MHz within the 2.4 GHz may have a plurality of channel indices (e.g., an index 1 to an index 14). For example, a center frequency of a 20 MHz channel to which a channel index 1 is allocated may be 2.412 GHz, a center frequency of a 20 MHz channel to which a channel index 2 is allocated may be 2.417 GHz, and a center frequency of a 20 MHz channel to which a channel index N is allocated may be (2.407+0.005*N) GHz. The channel index may be called in various terms such as a channel number or the like. Specific numerical values of the channel index and center frequency may be changed.

FIG. 9 exemplifies 4 channels within a 2.4 GHz band. Each of 1st to 4th frequency domains 910 to 940 shown herein may include one channel. For example, the 1st frequency domain 910 may include a channel 1 (a 20 MHz channel having an index 1). In this case, a center frequency of the channel 1 may be set to 2412 MHz. The 2nd frequency domain 920 may include a channel 6. In this case, a center frequency of the channel 6 may be set to 2437 MHz. The 3rd frequency domain 930 may include a channel 11. In this case, a center frequency of the channel 11 may be set to 2462 MHz. The 4th frequency domain 940 may include a channel 14. In this case, a center frequency of the channel 14 may be set to 2484 MHz.

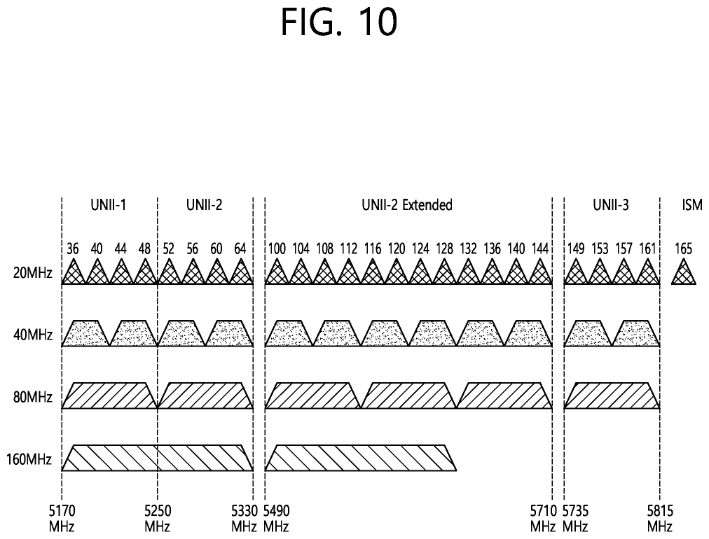

FIG. 10 illustrates an example of a channel used/supported/defined within a 5 GHz band.

The 5 GHz band may be called in other terms such as a second band or the like. The 5 GHz band may imply a frequency domain in which channels of which a center frequency is greater than or equal to 5 GHz and less than 6 GHz (or less than 5.9 GHz) are used/supported/defined. Alternatively, the 5 GHz band may include a plurality of channels between 4.5 GHz and 5.5 GHz. A specific numerical value shown in FIG. 10 may be changed.

A plurality of channels within the 5 GHz band include an unlicensed national information infrastructure (UNII)-1, a UNII-2, a UNII-3, and an ISM. The INII-1 may be called UNII Low. The UNII-2 may include a frequency domain called UNII Mid and UNII-2Extended. The UNII-3 may be called UNII-Upper.

A plurality of channels may be configured within the 5 GHz band, and a bandwidth of each channel may be variously set to, for example, 20 MHz, 40 MHz, 80 MHz, 160 MHz, or the like. For example, 5170 MHz to 5330 MHz frequency domains/ranges within the UNII-1 and UNII-2 may be divided into eight 20 MHz channels. The 5170 MHz to 5330 MHz frequency domains/ranges may be divided into four channels through a 40 MHz frequency domain. The 5170 MHz to 5330 MHz frequency domains/ranges may be divided into two channels through an 80 MHz frequency domain. Alternatively, the 5170 MHz to 5330 MHz frequency domains/ranges may be divided into one channel through a 160 MHz frequency domain.

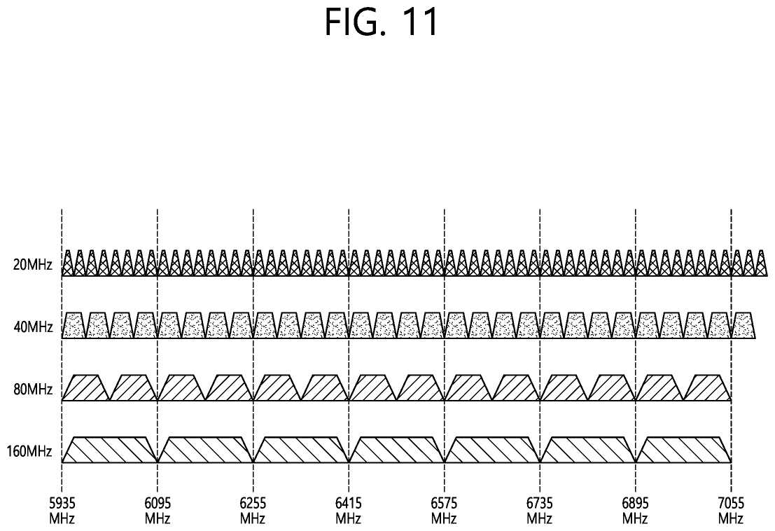

FIG. 11 illustrates an example of a channel used/supported/defined within a 6 GHz band.

The 6 GHz band may be called in other terms such as a third band or the like. The 6 GHz band may imply a frequency domain in which channels of which a center frequency is greater than or equal to 5.9 GHz are used/supported/defined. A specific numerical value shown in FIG. 11 may be changed.

For example, the 20 MHz channel of FIG. 11 may be defined starting from 5.940 GHz. Specifically, among 20 MHz channels of FIG. 11, the leftmost channel may have an index 1 (or a channel index, a channel number, etc.), and 5.945 GHz may be assigned as a center frequency. That is, a center frequency of a channel of an index N may be determined as (5.940+0.005*N) GHz.

Accordingly, an index (or channel number) of the 2 MHz channel of FIG. 11 may be 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, 197, 201, 205, 209, 213, 217, 221, 225, 229, 233. In addition, according to the aforementioned (5.940+0.005*N) GHz rule, an index of the 40 MHz channel of FIG. 11 may be 3, 11, 19, 27, 35, 43, 51, 59, 67, 75, 83, 91, 99, 107, 115, 123, 131, 139, 147, 155, 163, 171, 179, 187, 195, 203, 211, 219, 227.

Although 20, 40, 80, and 160 MHz channels are illustrated in the example of FIG. 11, a 240 MHz channel or a 320 MHz channel may be additionally added.

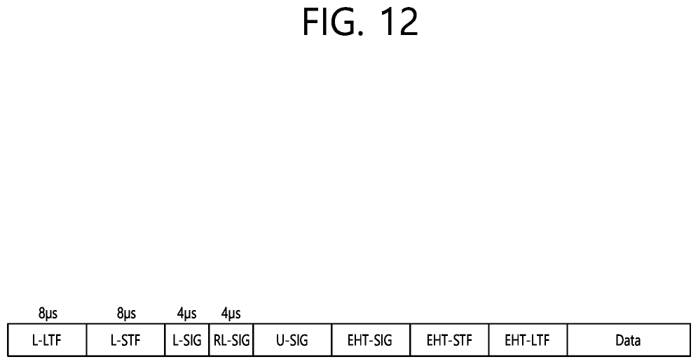

FIG. 12 illustrates an example of a PPDU used in the present specification.

The PPDU of FIG. 12 may be called in various terms such as an EHT PPDU, a TX PPDU, an RX PPDU, a first type or N-th type PPDU, or the like. For example, in the present specification, the PPDU or the EHT PPDU may be called in various terms such as a TX PPDU, a RX PPDU, a first type or N-th type PPDU, or the like. In addition, the EHT PPDU may be used in an EHT system and/or a new WLAN system enhanced from the EHT system.

The PPDU of FIG. 12 may indicate the entirety or part of a PPDU type used in the EHT system. For example, the example of FIG. 12 may be used for both of a single-user (SU) mode and a multi-user (MU) mode. In other words, the PPDU of FIG. 12 may be a PPDU for one receiving STA or a plurality of receiving STAs. When the PPDU of FIG. 12 is used for a trigger-based (TB) mode, the EHT-SIG of FIG. 12 may be omitted. In other words, a STA which has received a trigger frame for uplink-MU (UL-MU) may transmit the PPDU in which the EHT-SIG is omitted in the example of FIG. 12.

In FIG. 12, an L-STF to an EHT-LTF may be called a preamble or a physical preamble, and may be generated/transmitted/received/obtained/decoded in a physical layer.

A subcarrier spacing of the L-STF, L-LTF, L-SIG, RL-SIG, U-SIG, and EHT-SIG fields of FIG. 12 may be determined as 312.5 kHz, and a subcarrier spacing of the EHT-STF, EHT-LTF, and Data fields may be determined as 78.125 kHz. That is, a tone index (or subcarrier index) of the L-STF, L-LTF, L-SIG, RL-SIG, U-SIG, and EHT-SIG fields may be expressed in unit of 312.5 kHz, and a tone index (or subcarrier index) of the EHT-STF, EHT-LTF, and Data fields may be expressed in unit of 78.125 kHz.

In the PPDU of FIG. 12, the L-LTE and the L-STF may be the same as those in the conventional fields.

The L-SIG field of FIG. 12 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-HT, HT, VHT PPDU or an EHT PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI or the EHT PPDU, the value of the length field may be determined as a multiple of 3, and for the HE PPDU, the value of the length field may be determined as “a multiple of 3”+1 or “a multiple of 3”+2.

For example, the transmitting STA may apply BCC encoding based on a 1/2 coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier{subcarrier index −21, −7, +7, +21} and a DC subcarrier{subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index {−28, −27, +27, +28}. The aforementioned signal may be used for channel estimation on a frequency domain corresponding to {−28, −27, +27, +28}.

The transmitting STA may generate an RL-SIG generated in the same manner as the L-SIG. BPSK modulation may be applied to the RL-SIG. The receiving STA may know that the RX PPDU is the HE PPDU or the EHT PPDU, based on the presence of the RL-SIG.

A universal SIG (U-SIG) may be inserted after the RL-SIG of FIG. 12. The U-SIB may be called in various terms such as a first SIG field, a first SIG, a first type SIG, a control signal, a control signal field, a first (type) control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 μs. Each symbol of the U-SIG may be used to transmit the 26-bit information. For example, each symbol of the U-SIG may be transmitted/received based on 52 data tomes and 4 pilot tones.

Through the U-SIG (or U-SIG field), for example, A-bit information (e.g., 52 un-coded bits) may be transmitted. A first symbol of the U-SIG may transmit first X-bit information (e.g., 26 un-coded bits) of the A-bit information, and a second symbol of the U-SIB may transmit the remaining Y-bit information (e.g., 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=1/2 to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, “000000”.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits may indicate that the TX/RX PPDU is an EHT PPDU. In other words, when the transmitting STA transmits the EHT PPDU, the PHY version identifier of 3 bits may be set to a first value. In other words, the receiving STA may determine that the RX PPDU is the EHT PPDU, based on the PHY version identifier having the first value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a TXOP length and information related to a BSS color ID.

For example, when the EHT PPDU is divided into various types (e.g., various types such as an EHT PPDU related to an SU mode, an EHT PPDU related to a MU mode, an EHT PPDU related to a TB mode, an EHT PPDU related to extended range transmission, or the like), information related to the type of the EHT PPDU may be included in the version-dependent bits of the U-SIG.

For example, the U-SIG may include: 1) a bandwidth field including information related to a bandwidth; 2) a field including information related to an MCS scheme applied to EHT-SIG; 3) an indication field including information regarding whether a dual subcarrier modulation (DCM) scheme is applied to EHT-SIG; 4) a field including information related to the number of symbol used for EHT-SIG; 5) a field including information regarding whether the EHT-SIG is generated across a full band; 6) a field including information related to a type of EHT-LTF/STF; and 7) information related to a field indicating an EHT-LTF length and a CP length.

Preamble puncturing may be applied to the PPDU of FIG. 12. The preamble puncturing implies that puncturing is applied to part (e.g., a secondary 20 MHz band) of the full band. For example, when an 80 MHz PPDU is transmitted, a STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80 MHz band within the 160 MHz band (or 80+80 MHz band).

Information related to the preamble puncturing applied to the PPDU may be included in U-SIG and/or EHT-SIG. For example, a first field of the U-SIG may include information related to a contiguous bandwidth, and second field of the U-SIG may include information related to the preamble puncturing applied to the PPDU.

For example, the U-SIG and the EHT-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an EHT-SIG contiguous to the first U-SIG may include information related to a preamble puncturing applied to the second 80 MHz band (i.e., information related to a preamble puncturing pattern), and an EHT-SIG contiguous to the second U-SIG may include information related to a preamble puncturing (i.e., information related to a preamble puncturing pattern) applied to the first 80 MHz band.

Additionally or alternatively, the U-SIG and the EHT-SIG may include the information related to the preamble puncturing, based on the following method. The U-SIG may include information related to a preamble puncturing (i.e., information related to a preamble puncturing pattern) for all bands. That is, the EHT-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The EHT-SIG of FIG. 12 may include control information for the receiving STA. The EHT-SIG may be transmitted through at least one symbol, and one symbol may have a length of 4 μs. Information related to the number of symbols used for the EHT-SIG may be included in the U-SIG.

The PPDU of FIG. 12 may be determined (or identified) as an EHT PPDU based on the following method.

A receiving STA may determine a type of an RX PPDU as the EHT PPDU, based on the following aspect. For example, the RX PPDU may be determined as the EHT PPDU: 1) when a first symbol after an L-LTF signal of the RX PPDU is a BPSK symbol; 2) when RL-SIG in which the L-SIG of the RX PPDU is repeated is detected; and 3) when a result of applying “modulo 3” to a value of a length field of the L-SIG of the RX PPDU is detected as “0”. When the RX PPDU is determined as the EHT PPDU, the receiving STA may detect a type of the EHT PPDU (e.g., an SU/MU/Trigger-based/Extended Range type), based on bit information included in a symbol after the RL-SIG of FIG. 12. In other words, the receiving STA may determine the RX PPDU as the EHT PPDU, based on: 1) a first symbol after an L-LTF signal, which is a BPSK symbol; 2) RL-SIG contiguous to the L-SIG field and identical to L-SIG; 3) L-SIG including a length field in which a result of applying “modulo 3” is set to “0”; and 4) a 3-bit PHY version identifier of the aforementioned U-SIG (e.g., a PHY version identifier having a first value).

For example, the receiving STA may determine the type of the RX PPDU as the HE PPDU, based on the following aspect. For example, the RX PPDU may be determined as the HE PPDU: 1) when a first symbol after an L-LTF signal is a BPSK symbol; 2) when RL-SIG in which the L-SIG is repeated is detected; and 3) when a result of applying “modulo 3” to a value of a length field of the L-SIG is detected as “1” or “2”.

For example, the receiving STA may determine the type of the RX PPDU as a non-HT, HT, and VHT PPDU, based on the following aspect. For example, the RX PPDU may be determined as the non-HT, HT, and VHT PPDU: 1) when a first symbol after an L-LTF signal is a BPSK symbol; and 2) when RL-SIG in which L-SIG is repeated is not detected. In addition, even if the receiving STA detects that the RL-SIG is repeated, when a result of applying “modulo 3” to the length value of the L-SIG is detected as “0”, the RX PPDU may be determined as the non-HT, HT, and VHT PPDU.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 12. The PPDU of FIG. 12 may be used to transmit/receive frames of various types. For example, the PPDU of FIG. 12 may be used for a control frame. An example of the control frame may include a request to send (RTS), a clear to send (CTS), a power save-poll (PS-poll), BlockACKReq, BlockAck, a null data packet (NDP) announcement, and a trigger frame. For example, the PPDU of FIG. 12 may be used for a management frame. An example of the management frame may include a beacon frame, a (re-)association request frame, a (re-)association response frame, a probe request frame, and a probe response frame. For example, the PPDU of FIG. 12 may be used for a data frame. For example, the PPDU of FIG. 12 may be used to simultaneously transmit at least two or more of the control frame, the management frame, and the data frame.

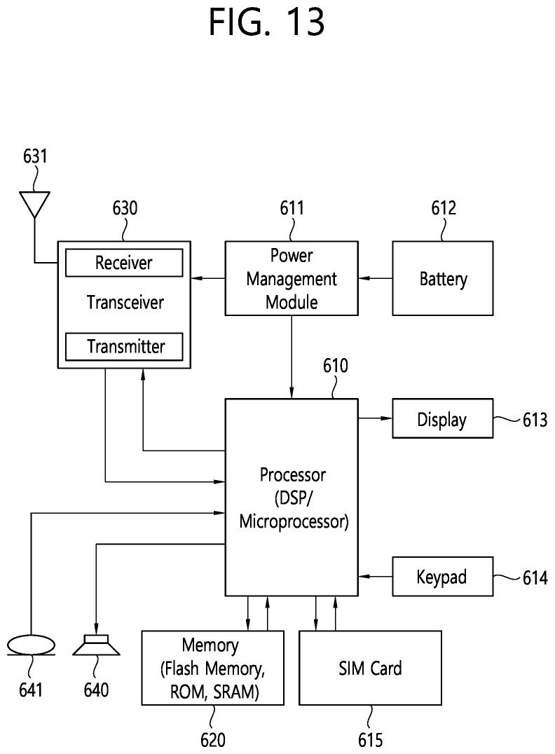

FIG. 13 illustrates an example of a modified transmission device and/or receiving device of the present specification.

Each device/STA of the sub-figure (a)/(b) of FIG. 1 may be modified as shown in FIG. 13. A transceiver 630 of FIG. 13 may be identical to the transceivers 113 and 123 of FIG. 1. The transceiver 630 of FIG. 13 may include a receiver and a transmitter.

A processor 610 of FIG. 13 may be identical to the processors 111 and 121 of FIG. 1. Alternatively, the processor 610 of FIG. 13 may be identical to the processing chips 114 and 124 of FIG. 1.

A memory 620 of FIG. 13 may be identical to the memories 112 and 122 of FIG. 1. Alternatively, the memory 620 of FIG. 13 may be a separate external memory different from the memories 112 and 122 of FIG. 1.

Referring to FIG. 13, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 13, a speaker 640 may output a result related to a sound processed by the processor 610. A microphone 641 may receive an input related to a sound to be used by the processor 610.

Hereinafter, technical features of channel bonding supported by the STA of the present disclosure will be described.

For example, in an IEEE 802.11n system, 40 MHz channel bonding may be performed by combining two 20 MHz channels. In addition, 40/80/160 MHz channel bonding may be performed in the IEEE 802.11ac system.

For example, the STA may perform channel bonding for a primary 20 MHz channel (P20 channel) and a secondary 20 MHz channel (S20 channel). A backoff count/counter may be used in the channel bonding process. The backoff count value may be chosen as a random value and decremented during the backoff interval. In general, when the backoff count value becomes 0, the STA may attempt to access the channel.

During the backoff interval, when the P20 channel is determined to be in the idle state and the backoff count value for the P20 channel becomes 0, the STA, performing channel bonding, determines whether an S20 channel has maintained an idle state for a certain period of time (for example, point coordination function interframe space (PIFS)). If the S20 channel is in an idle state, the STA may perform bonding on the P20 channel and the S20 channel. That is, the STA may transmit a signal (PPDU) through a 40 MHz channel (that is, a 40 MHz bonding channel) including a P20 channel and the S20 channel.

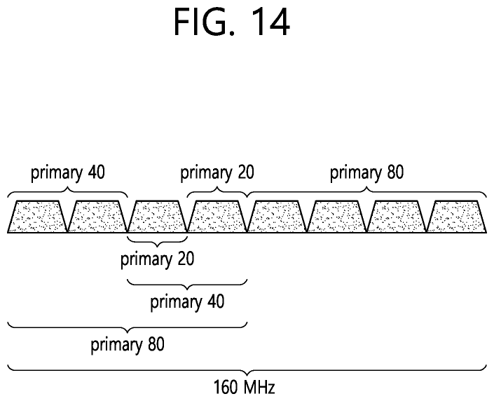

FIG. 14 illustrates an example of channel bonding. As shown in FIG. 14, the primary 20 MHz channel and the secondary 20 MHz channel may make up a 40 MHz channel (primary 40 MHz channel) through channel bonding. That is, the bonded 40 MHz channel may include a primary 20 MHz channel and a secondary 20 MHz channel.

Channel bonding may be performed when a channel contiguous to the primary channel is in an idle state. That is, the Primary 20 MHz channel, the Secondary 20 MHz channel, the Secondary 40 MHz channel, and the Secondary 80 MHz channel can be sequentially bonded. However, if the secondary 20 MHz channel is determined to be in the busy state, channel bonding may not be performed even if all other secondary channels are in the idle state. In addition, when it is determined that the secondary 20 MHz channel is in the idle state and the secondary 40 MHz channel is in the busy state, channel bonding may be performed only on the primary 20 MHz channel and the secondary 20 MHz channel.

Hereinafter, preamble puncturing supported by a STA in the present disclosure will be described.

For example, in the example of FIG. 14, if the Primary 20 MHz channel, the Secondary 40 MHz channel, and the Secondary 80 MHz channel are all in the idle state, but the Secondary 20 MHz channel is in the busy state, bonding to the secondary 40 MHz channel and the secondary 80 MHz channel may not be possible. In this case, the STA may configure a 160 MHz PPDU and may perform a preamble puncturing on the preamble transmitted through the secondary 20 MHz channel (for example, L-STF, L-LTF, L-SIG, RL-SIG, U-SIG, HE-SIG-A, HE-SIG-B, HE-STF, HE-LTF, EHT-SIG, EHT-STF, EHT-LTF, etc.), so that the STA may transmit a signal through a channel in the idle state. In other words, the STA may perform preamble puncturing for some bands of the PPDU. Information on preamble puncturing (for example, information about 20/40/80 MHz channels/bands to which puncturing is applied) may be included in a signal field (for example, HE-SIG-A, U-SIG, EHT-SIG) of the PPDU.

Hereinafter, technical features of a multi-link (ML) supported by a STA of the present disclosure will be described.

The STA (AP and/or non-AP STA) of the present disclosure may support multi-link (ML) communication. ML communication may refer to communication supporting a plurality of links. The link related to ML communication may include channels of the 2.4 GHz band shown in FIG. 9, the 5 GHz band shown in FIG. 10, and the 6 GHz band shown in FIG. 11 (for example, 20/40/80/160/240/320 MHz channels).

A plurality of links used for ML communication may be set in various ways. For example, a plurality of links supported by one STA for ML communication may be a plurality of channels in a 2.4 GHz band, a plurality of channels in a 5 GHz band, and a plurality of channels in a 6 GHz band. Alternatively, a plurality of links supported by one STA for ML communication may be a combination of at least one channel in the 2.4 GHz band (or 5 GHz/6 GHz band) and at least one channel in the 5 GHz band (or 2.4 GHz/6 GHz band). Meanwhile, at least one of the plurality of links supported by one STA for ML communication may be a channel to which preamble puncturing is applied.

The STA may perform an ML setup to perform ML communication. The ML setup may be performed based on a management frame or control frame such as a Beacon, a Probe Request/Response, an Association Request/Response, and the like. For example, information about ML setup may be included in an element field included in a Beacon, a Probe Request/Response, an Association Request/Response, and the like.

When ML setup is completed, an enabled link for ML communication may be determined. The STA may perform frame exchange through at least one of a plurality of links determined as an enabled link. For example, the enabled link may be used for at least one of a management frame, a control frame, and a data frame.

When one STA supports multiple links, a transceiver supporting each link may operate as one logical STA. For example, one STA supporting two links may be expressed as one Multi Link Device (MLD) including a first STA for the first link and a second STA for the second link. For example, one AP supporting two links may be expressed as one AP MLD including a first AP for a first link and a second AP for a second link. In addition, one non-AP supporting two links may be expressed as one non-AP MLD including a first STA for the first link and a second STA for the second link.

Hereinafter, more specific features related to the ML setup are described.

The MLD (AP MLD and/or non-AP MLD) may transmit, through ML setup, information on a link that the corresponding MLD can support. Link information may be configured in various ways. For example, information on the link may include at least one of 1) information on whether the MLD (or STA) supports simultaneous RX/TX operation, 2) information on the number/upper limit of uplink/downlink links supported by the MLD (or STA), 3) information on the location/band/resource of the uplink/downlink Link supported by the MLD (or STA), 4) information on the frame type (management, control, data, etc.) available or preferred in at least one uplink/downlink link, 5) information on ACK policy available or preferred in at least one uplink/downlink link, and 6) information on an available or preferred traffic identifier (TID) in at least one uplink/downlink Link. The TID is related to the priority of traffic data and is expressed as eight types of values according to the conventional wireless LAN standard. That is, eight TID values corresponding to four access categories (ACs) (AC_Background (AC_BK), AC_Best Effort (AC_BE), AC_Video (AC_VI), AC_Voice (AC_VO)) according to the conventional WLAN standard may be defined.

For example, it may be preset that all TIDs are mapped for uplink/downlink link. Specifically, if negotiation is not made through ML setup, if all TIDs are used for ML communication, and if the mapping between uplink/downlink link and TID is negotiated through additional ML settings, the negotiated TID may be used for ML communication.

Through ML setup, a plurality of links usable by the transmitting MLD and the receiving MLD related to ML communication may be set, and this may be referred to as an “enabled link”. The “enabled link” may be called differently in various expressions. For example, it may be referred to as various expressions such as a first link, a second link, a transmission link, and a reception link.

After the ML setup is completed, the MLD could update the ML setup. For example, the MLD may transmit information on a new link when it is necessary to update information on the link. Information on the new link may be transmitted based on at least one of a management frame, a control frame, and a data frame.

According to an embodiment, the MLD may include a non-AP MLD and an AP-MLD. The non-AP MLD and the AP-MLD may be classified according to the function of an access point (AP). The non-AP MLD and the AP-MLD may be physically separated or logically separated. For example, when the MLD performs an AP function, it may be referred to as an AP MLD, and when the MLD performs a STA function, it may be referred to as a non-AP MLD.

In the following specification, the MLD has one or more connected/associated STAs and has one MAC service access point (SAP) through an upper link layer (Logical Link Control, LLC). The MLD may mean a physical device or a logical device. Hereinafter, a device may mean the MLD.

In addition, the MLD may include at least one STA connected to each link of the multi-link. For example, the processor of the MLD may control the at least one STA. For example, the at least one STA may be independently configured and operated. The at least one STA may include a processor and a transceiver, respectively. For example, the at least one STA may operate independently regardless of the processor of the MLD.

In the following specification, for the convenience of description, it is described that the MLD (or the processor of the MLD) controls at least one STA, but is not limited thereto. As described above, the at least one STA may transmit/receive a signal independently regardless of the MLD.

According to an embodiment, the AP MLD or the non-AP MLD may be configured in a structure having a plurality of links. In other words, the non-AP MLD may support a plurality of links. The non-AP MLD may include a plurality of STAs. Each of a plurality of STAs may have a link for a corresponding STA.

MLD and STR Capability

The 802.11be standard (hereinafter, the EHT standard) may support a multi-link. Here, the multi-link may include multiple bands. That is, the multi-link may mean links included in several frequency bands, or may mean a plurality of links included in one frequency band.

The EHT standard may support Simultaneous TX/RX (STR) Channel access according to Link capability in a multi-link support environment. A device supporting a multi-link may be defined as a Non-AP/AP Multi-Link Device (MLD). STR Capability may mean that data (or signals) can be transmitted/received simultaneously in multiple links. That is, an MLD supporting STR capability (hereinafter, STR MLD) may receive data through one link when data transmission occurs on another link.

On the other hand, MLDs that do not support STR capability (hereinafter, non-STR MLDs) cannot simultaneously transmit and receive data (or signals) because data collision may occur due to interference. For example, when a non-STR MLD receives data (or a signal) from one link, it does not attempt transmission to another link to avoid interference. If data (or signal) transmission and reception occur simultaneously in both links, data (or signal) collision may occur.

In other words, the STR MLD may simultaneously perform signal transmission and signal reception in a multi-link, respectively. Non-STR MLD cannot simultaneously transmit and receive signals in a multi-link. While transmitting a signal in the first link among a multi-link, a STA that does not support the STR operation cannot receive a signal in a link different from the first link, but could transmit a signal. In addition, while receiving a signal in the first link among the multi-link, a STA that does not support the STR operation cannot transmit a signal in a link different from the first link, but could receive a signal.

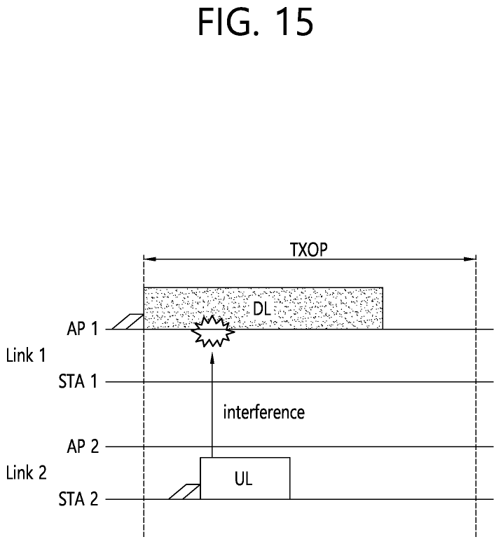

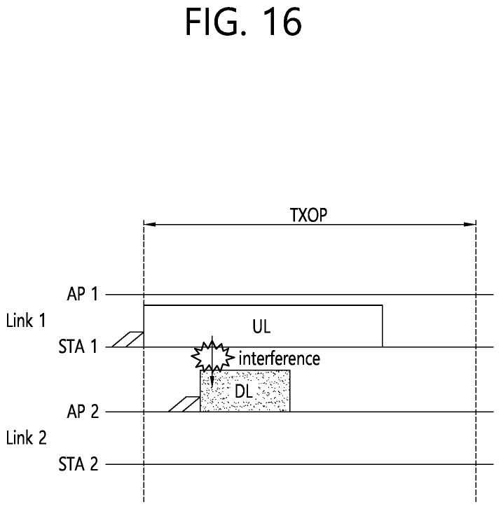

Hereinafter, examples in which collision may occur in the non-STR MLD may be described with reference to FIGS. 15 and 16.

FIG. 15 shows an example in which a collision may occur in a non-STR MLD.

Referring to FIG. 15, the AP MLD may include AP 1 operating in a first link and AP 2 operating in a second link. The non-AP MLD may include STA 1 operating in the first link and STA 2 operating in the second link. At least one of an AP MLD and a non-AP MLD may not support STR capability. The AP MLD may transmit a DL signal through AP 1. When the non-AP MLD transmits a UL signal through STA 2 while the non-AP MLD is receiving the DL signal through STA 1, a collision may occur.

FIG. 16 shows another example in which a collision may occur in a non-STR MLD.

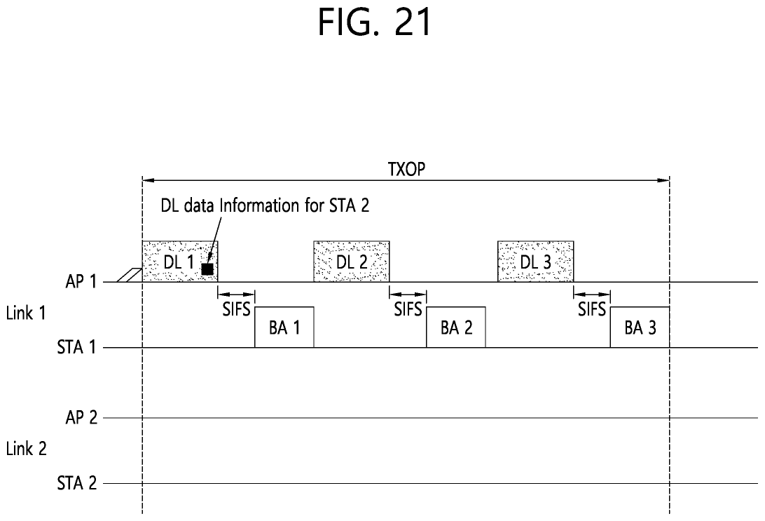

Referring to FIG. 16, an AP MLD and a non-AP MLD may correspond to the AP MLD and the non-AP MLD of FIG. 21, respectively. The non-AP MLD may transmit a UL signal through STA 1. When the AP MLD transmits the DL signal through AP 2, while transmitting the UL signal, a collision may occur.

Referring to FIGS. 15 and 16, when either one of the AP MLD or the non-AP MLD does not support STR capability, there may be restrictions on TX/RX operation. Due to the restrictions of the non-STR MLD operation, a specific section in which a link is not used (i.e. a section in which neither TX/RX occurs) may occur. A specific section in which the link is not used may cause unnecessary power consumption in the non-AP MLD.

Therefore, in the following specification, a power reduction method in consideration of the characteristics of a non-STR MLD that does not support simultaneous transmission/reception may be proposed. Additionally, an embodiment regarding NAV sharing applicable when only some STAs of the MLD enter the doze state may be proposed.

Specifically, when the MLD supports STR Capability in an environment where AP Multi-Link Device (MLD) and Non-AP MLD are connected by a plurality of links (or multi-links), transmission/reception of data (or signal) may occur simultaneously within the same TXOP. However, when any one of AP MLD and non-AP MLD is a non-STR device, if data (or signal) is simultaneously transmitted/received within the same TXOP, data (or signal) may be corrupted by interference. Accordingly, hereinafter, a power reduction technique for non-AP MLDs in consideration of the characteristics of such non-STR MLDs may be proposed.

Power Saving Mechanism Considering Non-STR Capability

In the following specification, for the convenience of description, it is described that the MLD (or the processor of the MLD) controls at least one STA, but is not limited thereto. As described above, the at least one STA may transmit/receive a signal independently regardless of the MLD.

An AP MLD and a non-AP MLD may be connected by a plurality of links. Hereinafter, for the convenience of description, technical features of the AP MLD and the non-AP MLD may be described through the structures of the two links, which are the most basic structures, of the AP MLD and the non-AP MLD. In addition, by assuming that the non-AP MLD is a non-STR MLD that does not support STR capability, technical features regarding the AP MLD and the non-AP MLD may be described.

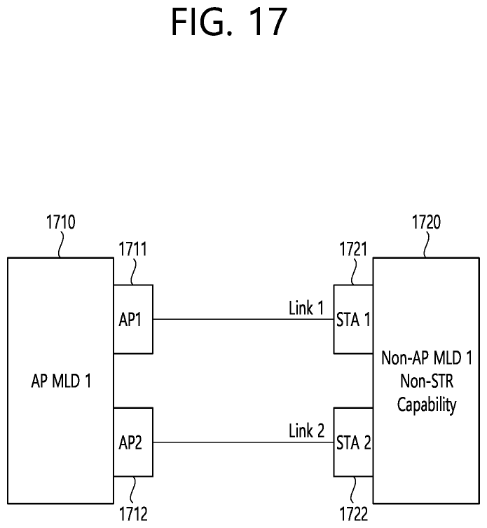

FIG. 17 shows the basic structures of an AP MLD and a non-AP MLD.

Referring to FIG. 17, AP MLD 1710 may include AP 1 1711 and AP 2 1712. The non-AP MLD 1720 may include STA 1 1721 and STA 2 1722. AP 1 1711 and STA 1 1721 may operate in link 1. Also, AP 1 1711 and STA 1 1721 may be connected through link 1. AP 2 1712 and STA 2 1722 may operate on link 2. Also, AP 2 1712 and STA 2 1722 may be connected through link 2. The non-AP MLD 1720 may not support STR Capability. That is, the non-AP MLD 1720 may be a non-STR MLD.

The structures of the AP MLD and the non-AP MLD described in the following specification may correspond to the structures of the AP MLD 1710 and the non-AP MLD 1720 of FIG. 17.

In addition, in the EHT standard, in order to reduce power consumption, a link may be divided into an anchored link or a non-anchored link. The anchored link or the non-anchored link can be called variously. For example, the anchored link may be called a primary link. The non-anchored link may be called a secondary link.

According to an embodiment, the AP MLD supporting multi-link can be managed by designating each link as an anchored link or a non-anchored link. AP MLD may support one or more Links among a plurality of Links as the anchored link. The non-AP MLD can be used by selecting one or more of its own anchored links from the Anchored Link List (the list of anchored links supported by the AP MLD).

For example, the anchored link may be used for non-data frame exchange (i.e. Beacon and Management frame) as well as frame exchange for synchronization. Also, a non-anchored link can be used only for data frame exchange.

The non-AP MLD can perform monitoring (or monitor) only the anchored link to receive the Beacon and Management frame during the idle period. Therefore, in the case of a non-AP MLD, it must be connected to at least one anchored link to receive a beacon and a management frame. The one or more anchored links should always maintain the enabled state. In contrast, the non-anchored links can only be used for data frame exchange. Therefore, the STA corresponding to the non-anchored link (or the STA connected to the non-anchored link) may enter a doze during the idle period when the channel/link is not used. This has the effect of reducing power consumption.

Example of Interference in the Non-AP MLD of the Non-STR Capability

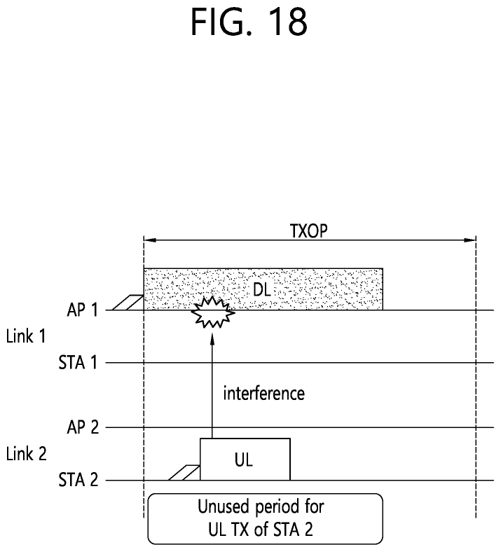

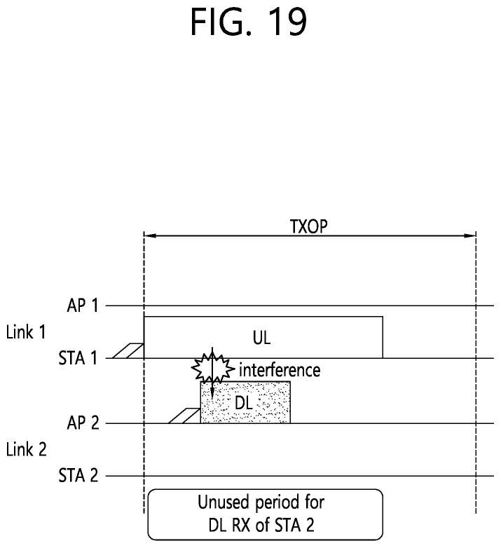

As described above, when the non-AP MLD is a non-STR MLD, when the non-AP MLD receives DL from the AP MLD or transmits UL to the AP MLD through a specific link, it may cause interference to a link other than the specific link. Also, in order to prevent data collision due to the interference, a section in which the link is not used for a specific period may occur. A specific example thereof may be described with reference to FIGS. 18 and 19.

FIG. 18 shows an example of a section in which a link is not used in a non-AP MLD.

Referring to FIG. 18, the AP MLD may transmit a DL PPDU through AP 1. When the non-AP MLD transmits the UL PPDU through STA 2, while the DL PPDU is being received, collision (or interference) may occur.

In other words, AP 1 of the AP MLD may transmit a DL PPDU. If STA 2 transmits a UL PPDU, while STA 1 is receiving the DL PPDU, a collision between the DL PPDU and the UL PPDU may occur.

Therefore, when STA 1 of the non-AP MLD receives a DL PPDU through Link 1, STA 2 should not attempt to transmit the UL PPDU to avoid interference until the DL PPDU reception is finished. That is, STA 2 cannot use the link 2 for UL PPDU transmission, until the reception of the DL PPDU by STA 1 is finished.

FIG. 19 shows another example of a section in which a link is not used in a non-AP MLD.

Referring to FIG. 19, an AP MLD and a non-AP MLD may correspond to the AP MLD and the non-AP MLD of FIG. 17, respectively. The non-AP MLD may transmit a UL PPDU through STA 1. When the AP MLD transmits the DL PPDU through AP 2, while transmitting the UL PPDU, collision (or interference) may occur.

In other words, STA 1 may transmit a UL PPDU through link 1. While STA 1 is transmitting a UL PPDU, when AP 2 transmits a DL PPDU through link 2, collision (or interference) between the UL PPDU and the DL PPDU may occur.

Therefore, when STA 1 of non-AP MLD 1 transmits a UL PPDU through Link 1, AP 2 should not attempt to transmit a DL PPDU to avoid interference until the UL PPDU transmission is finished. That is, STA 2 cannot use Link 2 for DL reception until the UL PPDU of STA 1 ends.

Referring to FIGS. 18 and 19, a specific interval that cannot be used for UL transmission or DL reception may occur due to the characteristics of the non-STR MLD. Accordingly, in the specific period, based on whether STA 2 transmits/receives data, STA 2 may enter a doze state to reduce power.

Hereinafter, in the case of receiving a DL (or DL PPDU) through the first link and transmitting a UL (or UL PPDU) through the first link, various embodiments in which a STA (for example, STA 2) enters a doze state to reduce power may be described. In addition, the AP MLD and the non-AP MLD may be configured based on the structure shown in FIG. 17.

Power Saving Mechanism when Receiving DL PPDU

Hereinafter, when the non-AP MLD receives DL data (or DL PPDU) from the AP MLD, a power-saving mechanism may be described.

In an environment where an AP MLD (Multi-Link Device) and a Non-AP MLD are connected by multiple links (or a multi-link), if MLD supports STR Capability, data (or signal) transmission/reception can occur simultaneously within the same TXOP. However, if either the AP MLD or the non-AP MLD is a non-STR MLD (or a non-STR device), data (or signal) transmission/reception cannot occur simultaneously in the same TXOP. Considering these characteristics, the MLD device can reduce unnecessary power consumption.

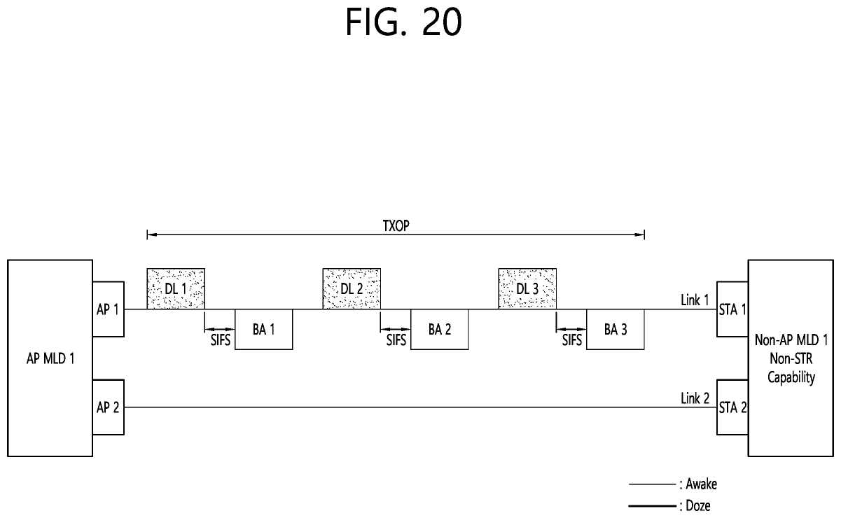

When the non-STR non-AP MLD receives DL data from the AP MLD, an example of operations of the non-AP MLD and the AP MLD may be described with reference to FIG. 20.

FIG. 20 shows an example of the operation of a non-AP MLD and an AP MLD.

Referring to FIG. 20, non-AP MLD 1 and AP MLD 1 may have the structures of non-AP MLD 1 and AP MLD 1 of FIG. 17. Non-AP MLD 1 may be a non-STR capability device (or a non-STR MLD) that does not support the STR capability.

STA 1 of Non-AP MLD 1 may receive a DL PPDU (or a DL signal) from AP 1 through Link 1. Until the DL PPDU reception is finished, STA 2 cannot transmit a UL PPDU (or UL signal) to avoid interference. STA 2 may only perform DL PPDU reception.

According to an embodiment, DL data transmission for STA 2 of AP 2 may not occur during the same DL TXOP period. In this case, a period in which neither UL data transmission nor DL data reception occurs until DL PPDU transmission in STA 2 is completed. During this period, STA 2 may enter a doze state (or a power-saving state, a sleep state, or an Unavailable state for Other Links) to reduce power.

A situation in which the aforementioned AP 2 considers that DL data transmission does not occur with respect to STA 2 is as follows.

i) The first example of a situation in which AP 2 considers that DL data transmission does not occur to STA 2 is a case in which AP 2 does not have DL data to transmit to STA 2.

ii) A second example of a situation in which AP 2 considers that DL data transmission does not occur to STA 2 is a case in which AP 2 has DL data to transmit to STA 2 but cannot transmit it because the channel is in a busy state.

In the above two cases, STA 2 may determine that it is impossible to receive DL data and enter a doze state to reduce power. For this, the AP MLD needs to inform/indicate this information to the non-AP MLD in the DL data.

That is, in order to enter the doze state for power reduction by STA 2, it should be noted that the DL PPDU is not transmitted through Link 2 during the TXOP period. Therefore, when AP 1 transmits a DL PPDU to STA 1, information on whether to transmit a DL PPDU in Link 2 may be transmitted together. Specifically, when AP 1 transmits a DL PPDU to STA 1, it may indicate (or inform) that DL data transmission to STA 2 by AP 2 does not occur during the same TXOP period. An embodiment related thereto may be described with reference to FIG. 21.

FIG. 21 shows another example of the operation of a non-AP MLD and an AP MLD.

Referring to FIG. 21, when DL frame (for example, DL 1, DL 2, DL3) transmission occurs only in some links (for example, Link 1) in a TXOP, AP MLD 1 may transmit information (for example, traffic indicator information (or TIM information included in the beacon of link 2)) on whether or not to receive DL data by a STA (for example, STA 2) connected to Link 2 via the DL frame. STA 1 may check information on whether or not there is a data buffer for STA 2 based on the information on whether or not to receive the DL data.

For example, a new field may be defined to display/transmit information on whether or not to receive the DL data. As another example, an existing TIM element may be reused to display/transmit information on whether or not the DL data is received.

For example, the information on whether or not to receive the DL data may be included in the DL frame. Information on whether to receive DL data or not included in the DL frame may be omitted in the case of a STA that does not have content/item to indicate. When information on whether or not to receive DL data is omitted, STA 2 may determine that there is no data buffered therein.

For example, only DL transmission for STA 1 may occur within the same TXOP. In this case, AP MLD 1 (for example, AP 1) may transmit information indicating that only DL transmission for STA 1 will occur via a DL frame. In this case, the non-AP MLD 1 receiving the DL frame through Link 1 can confirm that there is no DL data transmitted to STA 2 within the same TXOP period (or DL TXOP period) based on the above information. Accordingly, based on the information, STA 2 may enter the doze state.

However, in the above-described second case, although AP 2 has DL data to be transmitted to the STA 2, it may not be transmitted due to a channel state. Since STA 2 has entered the doze state, AP 2 needs to buffer data until STA 2 wakes up.

Hereinafter, various embodiments regarding a period in which STA 2 enters a doze state may be described.

### The First Embodiment

Hereinafter, for the convenience of description, at least one STA that receives a DL frame may be described as a first STA. Also, for the convenience of description, STAs distinguished from the first STA that do not receive the DL frame may be described as second STAs.

According to the first embodiment, the Non-AP MLD may receive a DL frame from the AP MLD through at least one STA. The first STA may check the TXOP field information included in the PHY header of the DL frame and/or the Duration field included in the MAC header. Then, if DL and UL transmission does not occur through the second STA (or the link to which the second STA is connected) during the TXOP period/interval, the non-AP MLD may change the state of the second STA to the Doze state. As the second STA enters the Doze state (or the Power-saving state, the sleep state, or the Unavailable state for Other Links) during the TXOP period, power consumption can be reduced. Thereafter, the second STA that has entered the Doze state may change the state to the Awake state after the TXOP duration ends.

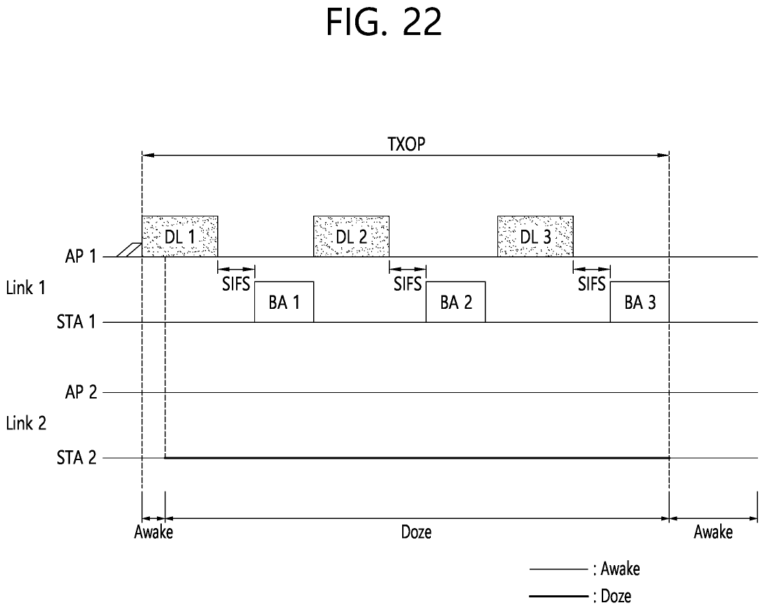

FIG. 22 show another example of the operations of a non-AP MLD and an AP MLD.

Referring to FIG. 22, STA 1 may be an example of the above-described first STA. STA 2 may be an example of the above-described second STA. AP MLD 1 (for example, AP 1) may acquire TXOP from Link 1.

AP 1 may transmit DL 1 to non-AP MLD 1 (for example, STA 1) within the TXOP. DL 1 may include information on whether to transmit a DL frame through link 2. In other words, DL 1 may include information about data buffered in AP 2.

STA 1 may receive DL 1. STA 1 may acquire information on whether to transmit a DL frame through link 2 together. The non-AP MLD 1 may confirm that a DL frame through link 2 will not be transmitted based on DL 1. In other words, the non-AP MLD 1 may confirm that there is no data buffered in AP 2 based on the DL 1.

Accordingly, the non-AP MLD 1 may change the state of STA 2 from the awake state to the doze state based on the DL 1. In other words, STA 2 may enter a doze state based on DL 1.

For example, the time point at which STA 2 enters the doze state may be a time point at which non-AP MLD 1 (for example, STA 1) knows whether data is transmitted to itself through a DL frame (for example, DL 1). For example, the time point at which STA 2 enters the doze state may be the time point at which non-AP MLD 1 (for example, STA 1) checks the STAID field value of the PHY Header of the SU/MU PPDU or the RA value of the MAC Header of the SU/MU PPDU.

For another example, the time point at which STA 2 enters the doze state may be a time point at which non-AP MLD 1 recognizes that there is no DL frame (for example, DL 1) transmitted to STA 2 within the same DL TXOP period. For example, the time point at which STA 2 enters the doze state may be the time point at which DL frame presence indication information for STA 2 in the DL frame of STA 1 is checked.

As another example, the time point at which STA 2 enters the doze state may be the time point at which the DL frame is transmitted.

According to an embodiment, the non-AP MLD 1 may change the state of STA 2 from the doze state to the awake state at the time point at which the TXOP is terminated. In other words, STA 2 may enter the awake state at a time point at which TXOP is terminated.

### The Second Embodiment

Hereinafter, for the convenience of description, at least one STA that receives the DL frame may be described as a first STA. Also, for the convenience of description, STAs distinguished from the first STA that do not receive the DL frame may be described as the second STA.

According to the second embodiment, the non-AP MLD may set/change the state of the second STA to the doze state until the end of receiving the DL frame. In other words, the second STA may maintain the doze state until the first STA finishes receiving the DL frame. According to the second embodiment, there is the effect of reducing power consumption.

In the first embodiment, during DL TXOP (TXOP in which a DL frame is transmitted), the non-AP MLD sets the second STA to the doze state. Unlike the first embodiment, the second embodiment may set/change the state of the second STA to the doze state until the DL frame reception ends. Compared with the first embodiment, the second embodiment has the effect of increasing link utilization. However, compared to the first embodiment, the transmission opportunity (for example, channel access) increases, but power efficiency may decrease.

Specifically, when the first STA receives the DL frame, it may consider that DL and UL transmission does not occur in the second STA. For example, the first STA may confirm that DL and UL transmission does not occur through the link connected to the second STA based on the DL frame. Accordingly, the second STA may enter the doze state until the end of receiving the DL frame. The second STA may enter the awake state after receiving the DL frame.

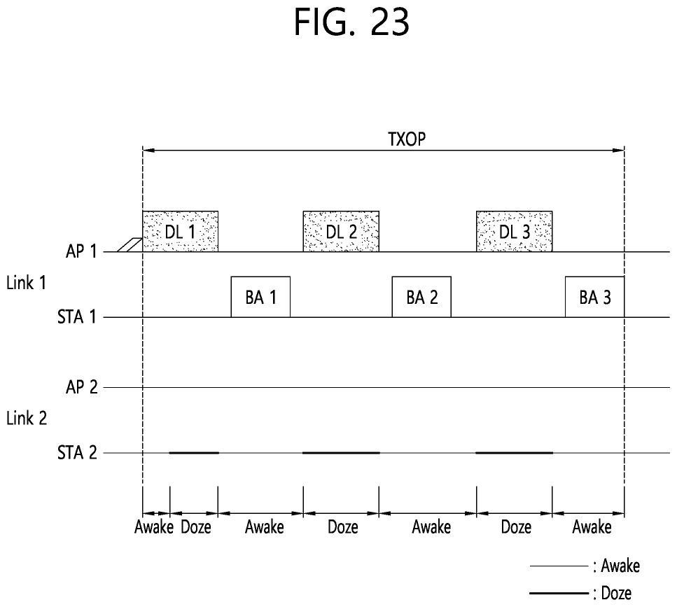

FIG. 23 shows another example of the operation of a non-AP MLD and an AP MLD.

Referring to FIG. 23, STA 1 may be an example of the above-described first STA. STA 2 may be an example of the above-described second STA. A plurality of DL frames may be transmitted during the TXOP period. AP MLD 1 (for example, AP 1) may acquire a TXOP from Link 1.

AP 1 may transmit DL 1 to non-AP MLD 1 (for example, STA 1) within the TXOP. DL 1 may include information on whether to transmit a DL frame through link 2. In other words, DL 1 may include information about data buffered in AP 2.

STA 1 may receive DL 1. STA 1 may acquire information on whether to transmit a DL frame through link 2, together. The non-AP MLD 1 may confirm that a DL frame through link 2 will not be transmitted based on DL 1. In other words, the non-AP MLD 1 may confirm that there is no data buffered in AP 2 based on the DL 1.

Accordingly, the non-AP MLD 1 may change the state of STA 2 from the awake state to the doze state based on the DL 1. In other words, STA 2 may enter a doze state based on DL 1.

For example, the time when STA 2 enters the doze state may be a time when non-AP MLD 1 knows whether data is transmitted to itself through a DL frame (for example, DL 1). For example, the time when STA 2 enters the doze state may be a time when non-AP MLD 1 (for example, STA 1) checks the STAID field value of the PHY Header of the SU/MU PPDU or the RA value of the MAC Header of the SU/MU PPDU.

For another example, the time when STA 2 enters the doze state may be a time when non-AP MLD 1 recognizes that there is no DL frame (for example, DL 1) transmitted to STA 2 within the same DL TXOP period. For example, the time when STA 2 enters the doze state may be a time when non-AP MLD 1 checks DL frame presence or absence indication information for STA 2 within a DL frame received from STA 1.

As another example, the time point at which STA 2 enters the doze state may be the time point at which DL 1 is transmitted.

According to an embodiment, the non-AP MLD 1 may change the state of STA 2 from the doze state to the awake state at the time point when DL 1 is terminated. The non-AP MLD 1 may operate in the same manner as described above even when DL 2 and DL 3 are received.

When multiple DL frames (for example, DL 1, DL 2 and DL 3) are transmitted through Link 1 during the DL TXOP period, STA 1 may transmit each Block Ack (BA) for each DL frame to AP 1 through UL transmission.

During a period in which UL data transmission for BA occurs, UL transmission through STA 2 may occur. Accordingly, the non-AP MLD 1 may change the state of STA 2 to the awake state every time the reception of the DL frame ends. In other words, STA 2 may change the state to the awake state whenever the reception of the DL frame ends. That is, STA 2 may transmit a UL frame during BA transmission by STA 1.

Therefore, according to the second embodiment, there is the effect of increasing link utilization. However, according to the second embodiment, the transmission opportunity (for example, channel access) may increase, but power efficiency may decrease.

### The Third Embodiment

Hereinafter, for the convenience of description, at least one STA that receives a DL frame may be described as a first STA. Also, for convenience of description, STAs distinguished from the first STA that do not receive the DL frame may be described as second STAs.

According to the third embodiment, when multiple DL frames are transmitted during the same TXOP, the non-AP MLD may set/change the state of the second STA to the doze state until the nth DL frame ends. n may mean the total number of DL frames transmitted by the AP MLD (for example, AP 1). The n-th DL frame may be changed according to the number of frames. That is, the n-th DL frame may mean the last transmitted frame. According to the third embodiment, there is the effect of reducing power consumption.

Specifically, when the first STA receives the DL frame, it may be assumed that DL and UL transmission does not occur in the second STA (or the link on which the second STA operates). For example, the first STA may confirm that DL and UL transmission does not occur through a link connected to the second STA based on the DL frame. Accordingly, the second STA may enter the doze state until the end point of the n-th DL frame reception. The second STA may enter the awake state after receiving the n-th DL frame. Information on the n-th DL frame may be transmitted while being included in the first transmitted DL frame or may be transmitted while being included in the last transmitted n-th DL frame. Accordingly, after entering the doze state, the second STA may change the state to the awake state at the end of receiving the n-th DL frame.

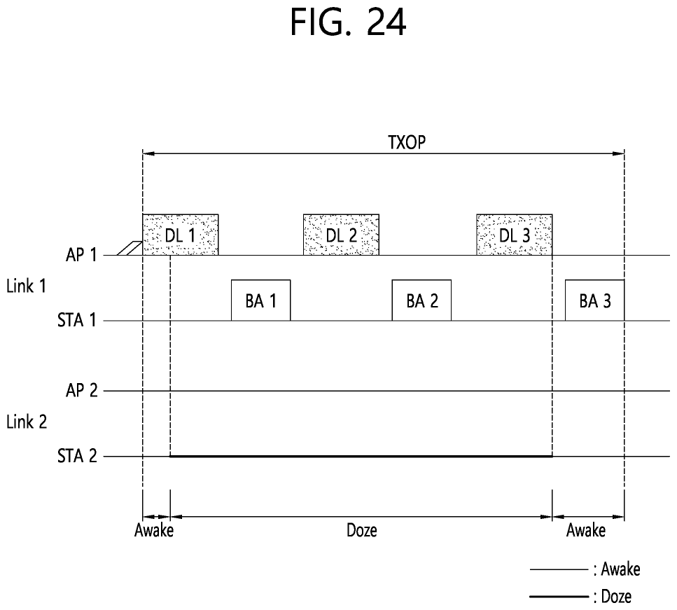

FIG. 24 shows another example of the operation of a non-AP MLD and an AP MLD.

Referring to FIG. 24, STA 1 may be an example of the above-described first STA. STA 2 may be an example of the above-described second STA. AP MLD 1 (for example, AP 1) may acquire TXOP from Link 1.

For example, the time point at which STA 2 enters the doze state may be the time point at which the non-AP MLD 1 knows whether data is transmitted to itself through a DL frame (for example, DL 1). For example, the time point at which STA 2 enters the doze state may be the time point at which the non-AP MLD 1 checks the STAID field value of the PHY Header of the SU/MU PPDU or the RA value of the MAC Header of the SU/MU PPDU.

For another example, the time point at which STA 2 enters the doze state may be a time point at which non-AP MLD 1 recognizes that there is no DL frame (for example, DL 1) transmitted to STA 2 within the same DL TXOP period. For example, the time point at which STA 2 enters the doze state may be a time point at which non-AP MLD 1 checks information indicating the presence or absence of DL frame for STA 2 in a DL frame received from STA 1.

For another example, the time point at which STA 2 enters the doze state may be a time point at which DL 1 transmission starts.

According to an embodiment, the non-AP MLD 1 may change the state of STA 2 from the doze state to the awake state when DL 3 ends.

### The Fourth Embodiment

Hereinafter, for the convenience of description, at least one STA that receives a DL frame may be described as a first STA. Also, for convenience of description, STAs distinguished from the first STA that do not receive the DL frame may be described as second STAs.

According to the fourth embodiment, the non-AP MLD may set/change the state of the second STA to the Doze state until (DL frame reception end time+SIFS+BA (or BACK/Block ACK) transmission time). In other words, the non-AP MLD may set the state of the second STA as Doze State when receiving the DL frame, in response to the DL frame, the status of the second STA can be maintained as the doze State until the transmission of BA after SIFS is completed. The second STA can enter the awake state after the end of the BA. According to the fourth embodiment, there is the effect that can reduce power consumption.

In the first embodiment, during DL TXOP (TXOP in which a DL frame is transmitted), the non-AP MLD sets the second STA to the Doze state. Unlike the first embodiment, the fourth embodiment may set/change the state of the second STA to the Doze state until the end of BA transmission.

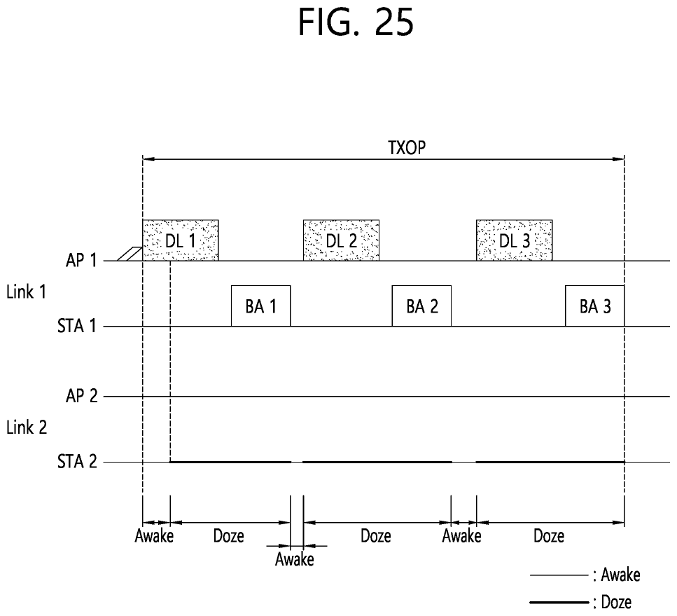

FIG. 25 shows another example of the operations of a non-AP MLD and an AP MLD.

Referring to FIGS. 25, STA 1 may be an example of the above-described first STA. STA 2 may be an example of the above-described second STA. A plurality of DL frames may be transmitted during the TXOP period. AP MLD 1 (for example, AP 1) may acquire TXOP from Link 1.

The non-AP MLD 1 may change the state of STA 2 from the awake state to the doze state based on the DL 1.

For example, the time point at which STA 2 enters the doze state may be the time point at which the non-AP MLD 1 knows whether data is transmitted to itself, through a DL frame (for example, DL 1). For example, the time point at which STA 2 enters the doze state may be the time point at which the non-AP MLD 1 checks the STAID field value of the PHY Header of the SU/MU PPDU or the RA value of the MAC Header of the SU/MU PPDU.

For another example, the time point at which STA 2 enters the doze state may be a time point at which non-AP MLD 1 recognizes that there is no DL frame (for example, DL 1) transmitted to STA 2 within the same DL TXOP period. For example, the time point at which STA 2 enters the doze state may be a time point at which non-AP MLD 1 checks DL frame presence or absence indication information for STA 2 in a DL frame received from STA 1.

As another example, the time point at which STA 2 enters the doze state may be the time point at which DL 1 is transmitted.

According to an embodiment, the non-AP MLD 1 may change the state of STA 2 from the doze state to the awake state at the time point at which the BA transmission ends. The non-AP MLD 1 may operate in the same manner as the above-described operation even when DL 2 and DL 3 are received.

Power-Saving Mechanism when Transmitting UL PPDU

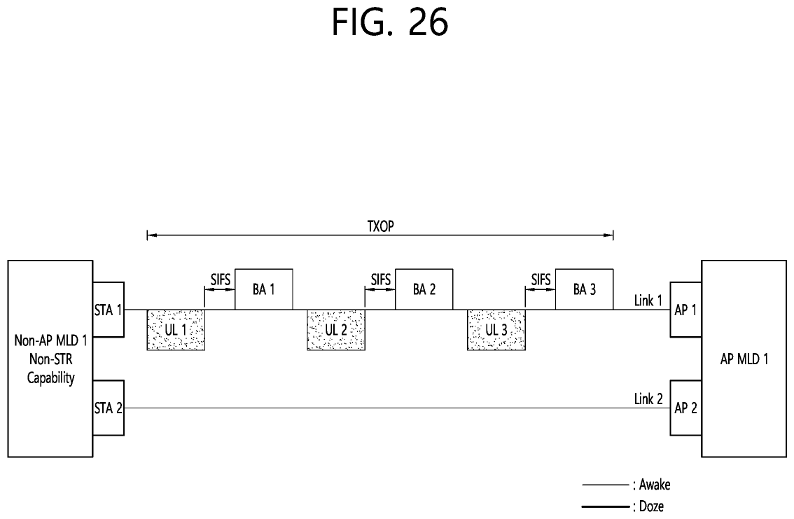

Hereinafter, when the non-AP MLD transmits UL data (or UL PPDU) to the AP MLD, a power-saving mechanism may be described. When the non-AP MLD transmits UL data (or UL PPDU) to the AP MLD, an example of the operation of the non-AP MLD and the AP MLD may be described with reference to FIG. 26.

FIG. 26 shows another example of the operation of a non-AP MLD and an AP MLD.

Referring to FIG. 26, non-AP MLD 1 and AP MLD 1 may have the structures of non-AP MLD 1 and AP MLD 1 of FIG. 17. Non-AP MLD 1 may be a non-STR capability device (or non-STR MLD) that does not support STR capability.

STA 1 of Non-AP MLD 1 may transmit a UL PPDU (or UL signal) to AP 1 through Link 1. Until the UL PPDU transmission is finished, AP 2 cannot transmit a second UL PPDU different from the UL PPDU (or a second UL signal different from the UL signal) to avoid interference. In other words, STA 2 cannot receive a DL PPDU (or a DL signal) to avoid interference until the UL PPDU transmission is finished. That is, STA 2 may only transmit the UL PPDU.

According to one embodiment, UL PPDU transmission to AP 2 may not occur during STA 2 during the same UL TXOP period. In this case, in STA 2, there is a section that does not generate both UL PPDU transmission/DL PPDU reception until the UL PPDU transmission is over. During this section, STA 2 can enter a Doze State (or a Power-saving State, a Sleep State, or an unavailable state for other links) to reduce power.

In the following specifications, various embodiments of the section where STA 2 enters the Doze State may be explained.

### The Fifth Embodiment

Hereinafter, for the convenience of description, at least one STA that transmits a UL frame may be described as a first STA. Also, for the convenience of description, STAs distinguished from the first STA that do not transmit the UL frame may be described as second STAs.

According to the fifth embodiment, the second STA may enter the doze state during the TXOP period of the UL data frame (or UL PPDU). Accordingly, there is the effect of reducing power consumption.

Specifically, if the first STA transmits the UL frame, it may be considered that no DL and UL transmission occurs in the second STA. In order to reduce power consumption, the second STA can enter the Doze State for itself during the TXOP period of the UL data frame. The second STA can enter the Doze State by itself when the first STA starts the UL frame transmission.

In order to reduce power consumption, the second STA that has entered the doze state by itself may maintain the doze state until the transmission of UL data is finished (for example, TXOP Duration of UL data). However, when the first STA fails to transmit UL data, the non-AP MLD 1 may change the state of STA 2 entering the doze state to the awake state.

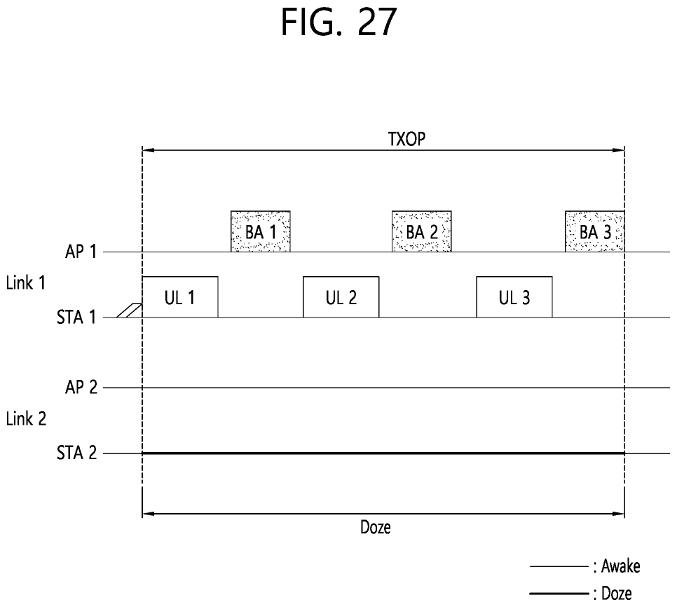

FIG. 27 shows another example of the operations of a non-AP MLD and an AP MLD.

Referring to FIGS. 27, STA 1 may be an example of the above-described first STA. STA 2 may be an example of the above-described second STA. A plurality of UL frames may be transmitted during the TXOP period. Non-AP MLD 1 (for example, STA 1) may acquire TXOP from Link 1.

STA 1 may transmit UL 1, UL 2, and UL 3 within the acquired TXOP. Non-AP MLD 1 can know that UL or DL data transmission does not occur in Link 2 during the TXOP. For example, non-AP MLD 1 may confirm that UL data transmission does not occur based on no data buffered in link 2. As another example, non-AP MLD 1 may confirm that DL data transmission does not occur based on BA 1 received from AP MLD 1 (for example, AP 1).

Accordingly, the non-AP MLD 1 may change STA 2 from the awake state to the doze state during the TXOP. In other words, STA 2 may enter a doze state during the TXOP. For example, the time point at which STA 2 enters the doze state may be a time point at which UL frame transmission starts.

Although not shown, when STA 1 fails to transmit UL 1, non-AP MLD 1 may change the state of STA 2 from a doze state to an awake state. For example, when STA 1 does not receive BA 1, non-AP MLD 1 may change the state of STA 2 from a doze state to an awake state.

According to an embodiment, even when STA 2 enters the doze state, when UL data to be transmitted from STA 2 is generated, it may change to an awake state and attempt UL data transmission.

### The Sixth Embodiment

Hereinafter, for the convenience of description, at least one STA that transmits a UL frame may be described as a first STA. Also, for the convenience of description, STAs distinguished from the first STA that do not transmit the UL frame may be described as second STAs.

According to the sixth embodiment, the Non-AP MLD can set/change the status of the second STA to a doze state until the time point at which the reception of the UL frame is terminated. According to the sixth embodiment, there is the effect that can reduce power consumption.

In the fifth embodiment, during the UL TXOP (TXOP where the UL frame is transmitted), non-AP MLD set the second STA to a doze state. Unlike the fifth embodiment, the sixth embodiment can set/change the status of the second STA to a doze state until the end of the UL frame transmission. The sixth embodiment has the effect of increasing the use of links compared to the fifth embodiment. However, compared to the fifth embodiment, although the transmission opportunity (for example, channel access) increases, the power efficiency could be reduced.

Specifically, when the first STA transmits the UL frame, it may be considered that DL and UL transmissions do not occur in the second STA. Accordingly, the second STA may enter the doze state until the end of the UL frame transmission. The second STA may enter the awake state after the transmission of the UL frame is terminated.

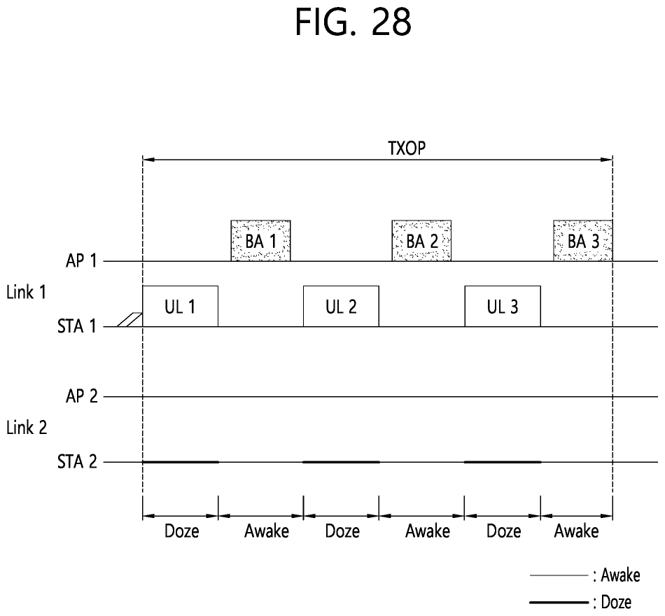

A specific example of the sixth embodiment may be described with reference to FIG. 28.

FIG. 28 shows another example of the operation of a non-AP MLD and an AP MLD.

Referring to FIG. 28, STA 1 may be an example of the above-described first STA. STA 2 may be an example of the above-described second STA. A plurality of UL frames may be transmitted during the TXOP period. Non-AP MLD 1 (for example, STA 1) may acquire TXOP from Link 1.

STA 1 may transmit UL 1, UL 2, and UL 3 within the acquired TXOP. It can be seen that non-AP MLD 1 does not generate UL or DL data transmission in Link 2 during the transmission period of UL 1. For example, non-AP MLD 1 may confirm that UL data transmission does not occur based on no data buffered in link 2.

Accordingly, the non-AP MLD 1 may change STA 2 from the awake state to the doze state during the transmission period of UL 1 (or the duration of UL 1). In other words, STA 2 may enter a doze state during the transmission period of UL 1. For example, the time point at which STA 2 enters the doze state may be a time point at which UL 1 transmission starts.

When a plurality of UL frames (for example, UL 1, UL 2, and UL 3) are transmitted through Link 1 during the UL TXOP period, STA 1 may receive each Block ACK (BA) for each UL frame from AP 1 through DL.

During a period in which DL data reception for BA occurs, the same DL data transmission may occur from AP 2. Accordingly, STA 2 may change the state to the awake state at every time at which the reception of DL frame reception is terminated. That is, STA 2 may receive a DL frame from AP 2 when receiving BA from STA 1.

Therefore, according to the sixth embodiment, there is the effect of increasing link utilization. However, according to the sixth embodiment, although the transmission opportunity may increase, power efficiency may decrease.

Although not shown, when STA 1 fails to transmit UL 1, the non-AP MLD 1 may change the state of STA 2 from a doze state to an awake state. For example, when STA 1 does not receive BA 1, non-AP MLD 1 may change the state of STA 2 from a doze state to an awake state.

According to an embodiment, even when STA 2 enters the doze state, when UL data to be transmitted from STA 2 occurs, STA 2 may change to an awake state and attempt UL data transmission.

### The Seventh Embodiment

Hereinafter, for the convenience of description, at least one STA that transmits a UL frame may be described as a first STA. Also, for the convenience of description, STAs distinguished from the first STA that do not transmit the UL frame may be described as second STAs.

According to the seventh embodiment, when multiple UL frames are transmitted during the same TXOP, the non-AP MLD may set/change the state of the second STA to the doze state until the nth UL frame ends. n may mean the total number of UL frames transmitted by the non-AP MLD (for example, STA 1). The n-th UL frame may be changed according to the number of frames. That is, the n-th UL frame may mean the last transmitted frame. According to the seventh embodiment, there is the effect of reducing power consumption.

Specifically, when the first STA transmits the UL frame, it may be considered that DL and UL transmission does not occur in the second STA (or the link on which the second STA operates). Accordingly, the second STA may enter the doze state until the time when the n-th UL frame transmission is terminated. The second STA may enter the awake state after the n-th UL frame transmission is terminated. Information on the n-th DL frame may be transmitted while being included in the first transmitted DL frame or may be transmitted while being included in the last transmitted n-th DL frame. Accordingly, after entering the doze state, the second STA may change the state to the awake state at the end of transmission of the n-th DL frame.

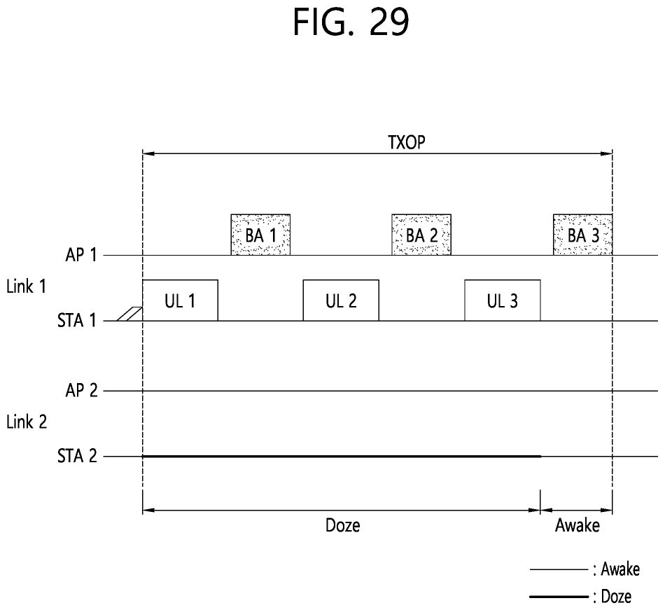

FIG. 29 shows another example of the operation of a non-AP MLD and an AP MLD.

Referring to FIG. 29, STA 1 may be an example of the above-described first STA. STA 2 may be an example of the above-described second STA. A plurality of UL frames may be transmitted during the TXOP period. Non-AP MLD 1 (for example, STA 1) may acquire TXOP from Link 1.

STA 1 may transmit UL 1, UL 2, and UL 3 within the acquired TXOP. The non-AP MLD 1 may change the state of STA 2 to the doze state until the end of the UL 3 transmission. In other words, STA 2 may maintain a doze state until the end of UL 3 transmission. For example, the time point at which STA 2 enters the doze state may be a time point at which UL 1 transmission starts. After entering the doze state, STA 2 may change the state from the doze state to the awake state at the UL 3 transmission end point.

Although not shown, when STA 1 fails to transmit UL 1, the non-AP MLD 1 may change the state of STA 2 from a doze state to an awake state. For example, when STA 1 does not receive BA 1, non-AP MLD 1 may change the state of STA 2 from a doze state to an awake state.

According to an embodiment, even when STA 2 enters the doze state, when UL data to be transmitted from STA 2 occurs, STA 2 may change to an awake state and attempt UL data transmission.

### The Eighth Embodiment

Hereinafter, for the convenience of description, at least one STA that transmits a UL frame may be described as a first STA. Also, for the convenience of description, STAs distinguished from the first STA that do not transmit the UL frame may be described as second STAs.

According to the eighth embodiment, the non-AP MLD may set/change the state of the second STA to the Doze state until (UL frame reception end time+SIFS+BA transmission time) in addition to the duration of the UL frame. In other words, the non-AP MLD may set the state of the second STA to the Doze state when transmitting the UL frame, and in response to the UL frame, the state of the second STA may be maintained in the doze state until the reception of the BA after SIFS is completed. The second STA may enter the awake state after BA reception is terminated. According to the eighth embodiment, there is the effect of reducing power consumption.

In the fifth embodiment, during DL TXOP (TXOP in which a DL frame is transmitted), the non-AP MLD sets the second STA to the doze state. Unlike the fifth embodiment, the eighth embodiment may set/change the state of the second STA to the doze state until the BA transmission ends.

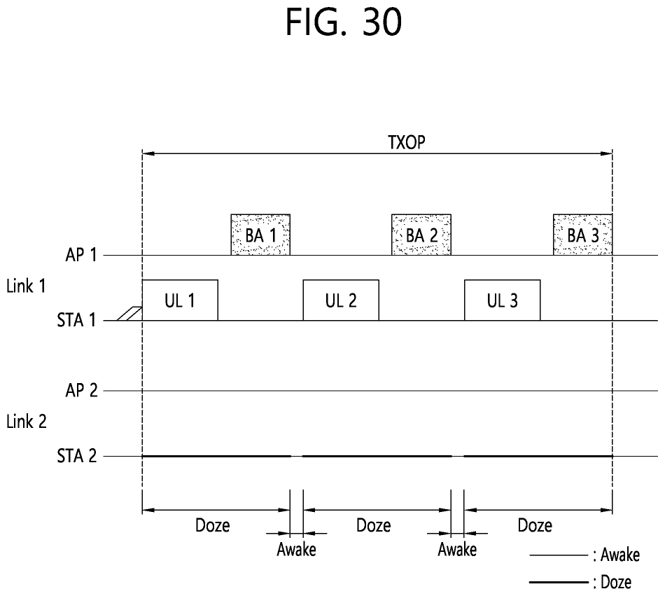

FIG. 30 shows another example of the operations of a non-AP MLD and an AP MLD.

Referring to FIG. 30, STA 1 may be an example of the above-described first STA. STA 2 may be an example of the above-described second STA. A plurality of UL frames may be transmitted during the TXOP period. Non-AP MLD 1 (for example, STA 1) may acquire TXOP from Link 1.

The non-AP MLD 1 may change the state of STA 2 from an awake state to a doze state based on UL 1.

For example, the time point at which STA 2 enters the doze state may be the time point at which UL 1 is transmitted.

According to an embodiment, the non-AP MLD 1 may change the state of STA 2 from the doze state to the awake state at the time point at which the BA transmission ends. The non-AP MLD 1 may operate in the same manner as the above-described operation even when DL 2 and DL 3 are received.

Although not shown, when STA 1 fails to transmit UL 1, the non-AP MLD 1 may change the state of STA 2 from a doze state to an awake state. For example, when STA 1 does not receive BA 1, non-AP MLD 1 may change the state of STA 2 from a doze state to an awake state.

According to an embodiment, even when STA 2 enters the doze state, when UL data to be transmitted from STA 2 occurs, STA 2 may change to an awake state and attempt UL data transmission.

Through the above-described embodiments, the non-AP MLD that does not support STR capability can reduce unnecessary power consumption.

An Embodiment of NAV Sharing for STAs Operating in Power Saving (Power Save Mode)

According to an embodiment, in various situations, only some STAs (that is, links) of the MLD may enter the doze state.

In the case of a conventional single link device, the STA operating in the power save mode cannot receive the updated NAV information of the AP when it enters the doze state. If the STA does not know the updated NAV information as described above, after the STA awakes from the doze state, a probe delay must be performed for a certain period to prevent data collision.

Unlike the above-described single link device, the multi-link device may transmit updated information of the AP connected to the STA entering the doze state through another link. Hereinafter, a method for transmitting updated information of an AP connected to a STA entering a doze state through another link may be proposed.

According to an embodiment, a multi-link device (MLD) may operate in a power save mode independently for each link. In other words, some STAs (for example, the first STA) of the MLD may operate in a doze state, that is, a link disable state due to the power save mode. Some other STAs (for example, the second STA) may operate in the awake state of the power save mode, in other words, may not operate in the power save mode. For example, some other STAs (for example, the second STA) may operate in an Available state and a link enable state.

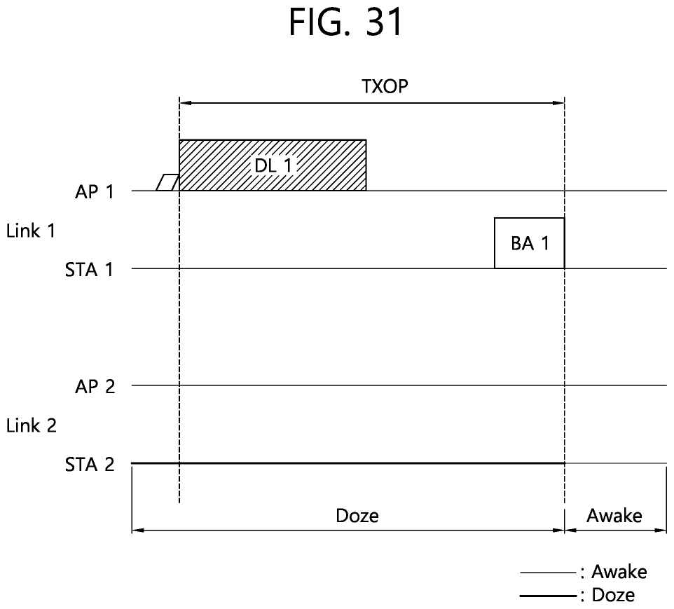

The above-described operation of the MLD may be described with reference to FIG. 31.

FIG. 31 shows another example of the operation of a non-AP MLD and an AP MLD.

Referring to FIG. 31, the non-AP MLD may be connected to the AP MLD through two links. In this case, only STA 2 may enter the doze state.

For example, Link 1 has an enable state, and Link 2 has a disable state. In other words, Link 1 may operate in an enable state, and Link 2 may operate in a disabled state. In other words, communication through link 1 may be possible, and communication through link 2 may not be possible.

In FIG. 31, it may be assumed that STA 2 wakes up at the end of DL TXOP of AP 1. FIG. 31 illustrates that STA 2 operates in a doze state before TXOP, however, STA 2 may change from an awake state to a doze state at the start of the TXOP period as in the above-described embodiments.

According to the conventional standard, since no information was obtained when STA 2 awakes and STA 2 is in a doze state, it is not known whether AP 2 currently transmits data to another STA (e.g. NAV information). Therefore, in this case, after awake, STA 2 should perform CCA until it detects a frame in which NAV can be set or at the same time as the probe delay expires. If the NAV of AP 2 is not set, performing CCA until the probe delay period expires may be overhead.

Therefore, in the following specification, when some STAs in the MLD (for example, non-AP MLD) enter the doze state, a method of transmitting NAV information of the AP connected to the STA entering the doze state through the link in the enable state may be proposed. Specifically, an embodiment in which the presence or absence of NAV information is indicated and an embodiment in which the NAV information is indicated by time may be sequentially described.

An Embodiment in which the Presence or Absence of NAV is Indicated as NAV Information

According to an embodiment, when STA 2 of a non-AP MLD wakes up, it may be indicated whether AP 2 of the AP MLD has data to transmit to a STA different from STA 2 of the non-AP MLD. For example, whether or not to set the NAV of AP 2 may be indicated through 1 bit. Referring to FIG. 31, AP 1 may transmit to STA 1 whether or not the NAV of AP 2 is set through 1 bit.

For the above-described embodiment, a new element or field may be proposed as follows. The name of a new element or field to be described below may be set in various ways and may be changed.

NAV indication (field/element): Whether there is a NAV set based on the time when the STA connected to the AP wakes up.

For example, if the value of the NAV indication (field/element) is a first value (for example, 1), the NAV indication may indicate that the NAV is set to transmit data to another STA at the time when the connected STA wakes up.

For another example, if the value of the NAV indication (field/element) is a second value (for example, 0), the NAV indication may indicate that the NAV is not set in order to transmit data to another STA at the time when the connected STA wakes up.

According to an embodiment, the value of the NAV indication (field/element) may be used together with a Link identifier (for example, Link ID), and in this case, NAV information may be indicated by being divided for each STA in the MLD.

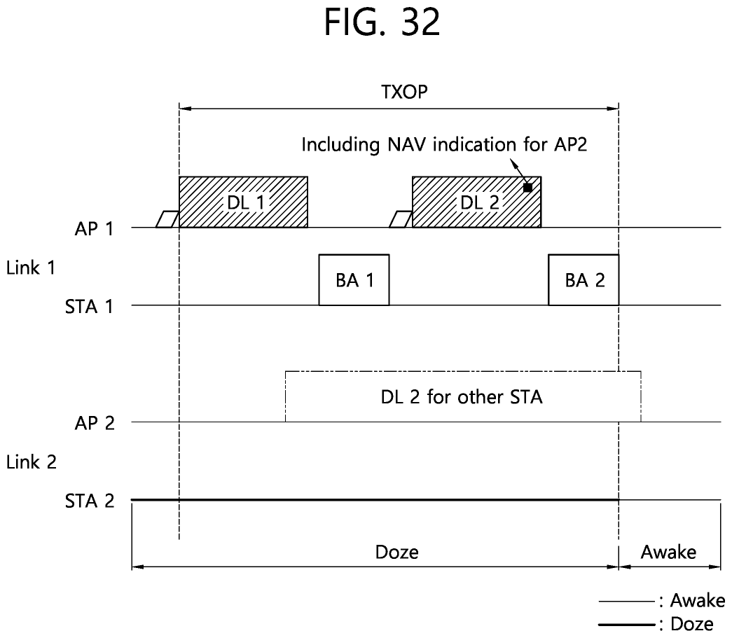

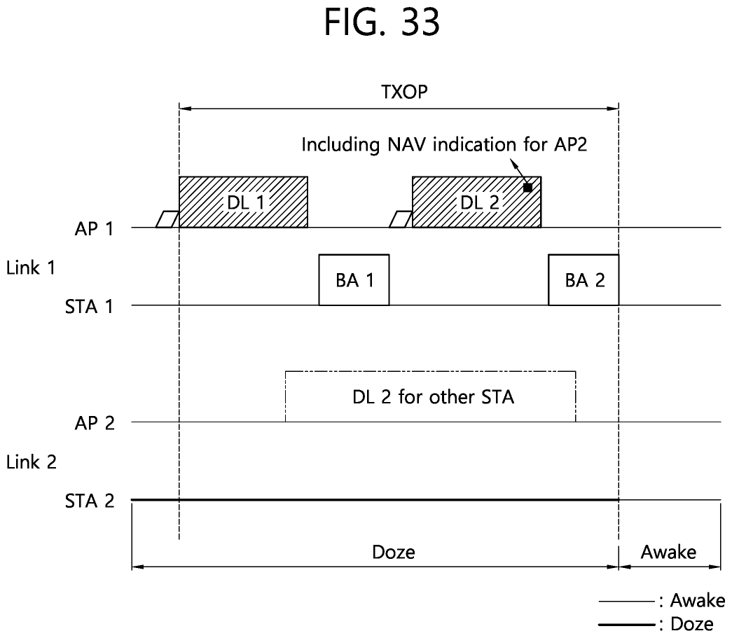

According to an embodiment, the first AP of the MLD operating in a plurality of links may transmit information about the second AP through a link connected to the first AP. Through the technical feature, the updated NAV information of the AP 2 may be transmitted for the STA 2 entering the doze state through the link in the awake state. A specific operation related thereto may be described with reference to FIGS. 32 and 33.

FIG. 32 shows another example of the operation of a non-AP MLD and an AP MLD.

Referring to FIG. 32, only STA 2 of the non-AP MLD may operate in a doze state, and STA 1 may operate in an awake state. Whether or not the NAV of the AP 2 is configured or not at the awake time of the STA 2 may be indicated through the NAV indication information through the DL 2 frame received by the STA 1 through Link 1.

The non-AP MLD having obtained the NAV indication information through DL 2 transmitted by AP 1 to STA 1 may share the NAV indication information with STA 2 through internal sharing. However, the AP MLD (or AP 1) must know when the STA 2 wakes up, so that it can inform whether the NAV of the connected AP 2 is set at the time when the STA wakes up.

For example, when STA 2 wakes up, since AP 2 is in a state where NAV for another STA is set, the value of the NAV indication (Field/element) may be set to 1 and transmitted. After awake, STA 2 may perform CCA until it detects a frame in which NAV can be set or at the same time as the probe delay expires.

FIG. 33 shows another example of the operation of a non-AP MLD and an AP MLD.

Referring to FIG. 33, there may be no NAV set by AP 2 at the time when STA 2 wakes up. Information indicating that the NAV set by the AP 2 does not exist may be transmitted while being included in the DL 2 transmitted by the AP 1.

The value of the NAV indication (field/element) in DL 2 may be set to 0 and transmitted to STA 1. Upon receiving this, STA 1 may share NAV indication information with STA 2 through the internal information sharing of the non-AP MLD.

STA 2 may know that there is no TXOP (or NAV) configured by AP 2 for other STAs at the time when STA 2 wakes up. Accordingly, STA 2 does not need to perform CCA until the probe delay expires.

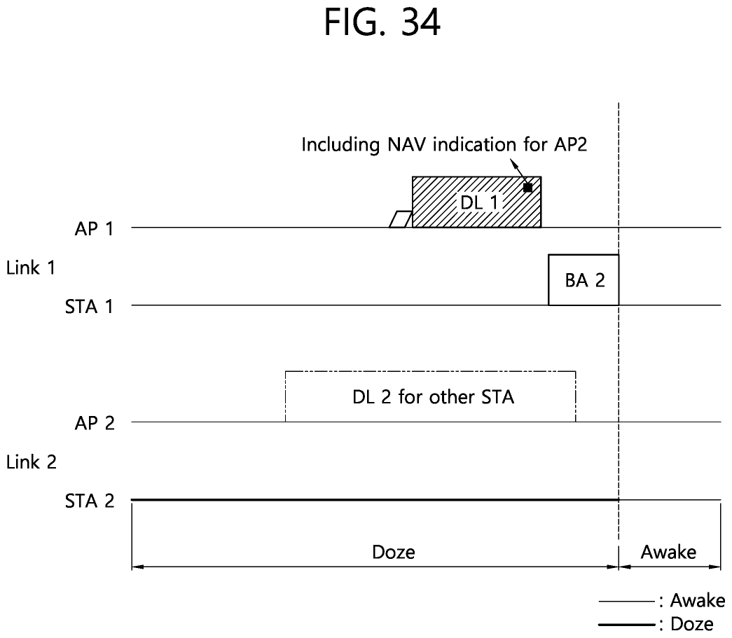

According to an embodiment, the NAV indication information may not be included in the DL transmitted by the AP, but may be transmitted in a separate frame as in the above-described embodiment. A detailed operation related thereto may be described with reference to FIG. 34.

FIG. 34 shows another example of the operation of a non-AP MLD and an AP MLD.

Referring to FIG. 34, AP 1 may transmit a separate message to inform STA 2 of the updated NAV information of AP 2 instead of a DL frame transmitted to STA 1. A separate message may be used when there is no DL frame transmitted from AP 1 to STA 1. Since the DL frame can be transmitted regardless of whether the AP 1 transmits the DL frame, there is an effect that information can be more flexibly informed to the STA 2. However, frame overhead may occur.

An Embodiment in which NAV Time is Indicated as NAV Information

According to an embodiment in which the NAV information is indicated by the presence or absence of NAV, whether the NAV of the AP is configured or not is simply indicated through 1 or 0. Although the above-described embodiment has the effect of reducing overhead, accuracy may be reduced. Therefore, hereinafter, an embodiment for notifying the STA of the NAV setting time of the connected AP may be proposed. A new element or field may be proposed to inform the STA of the NAV setting time of the connected AP. The name of a new element or field to be described below may be set in various ways and may be changed.

NAV time (field/element): NAV time set based on the time when the STA connected to the current AP wakes up.

For example, NAV time (field/element) may be expressed as NAV remaining time or NAV end time. In other words, the NAV time (field/element) may include information about the remaining NAV time or the NAV end time. Upon receiving the NAV time (field/element), the STA may predict (or check) the presence or absence of the NAV setting and the remaining time of the connected AP at the time when it wakes up.

According to an embodiment, the value of the NAV time (field/element) may be used together with a link identifier (for example, Link ID), and in this case, NAV information may be indicated by being divided for each STA in the MLD. According to an embodiment, the NAV time (field/element) may be transmitted together with the above-described NAV indication (field/element).

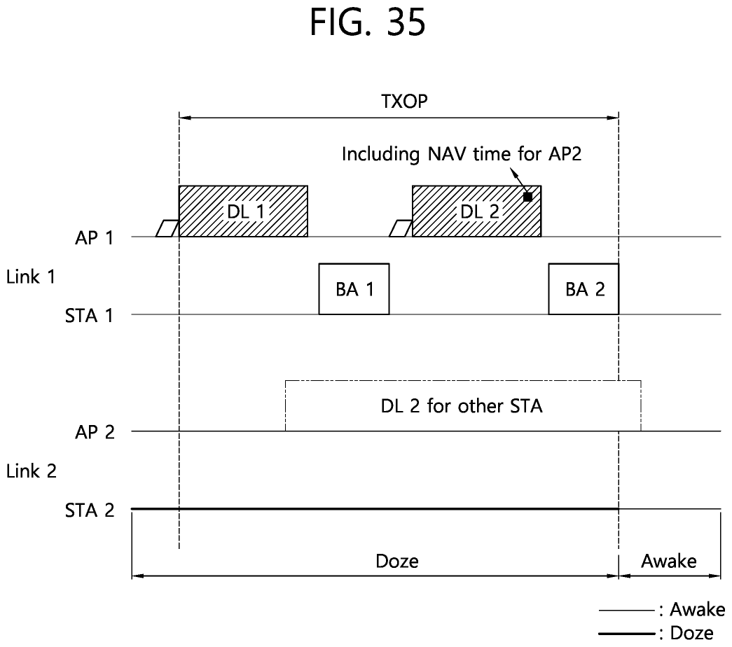

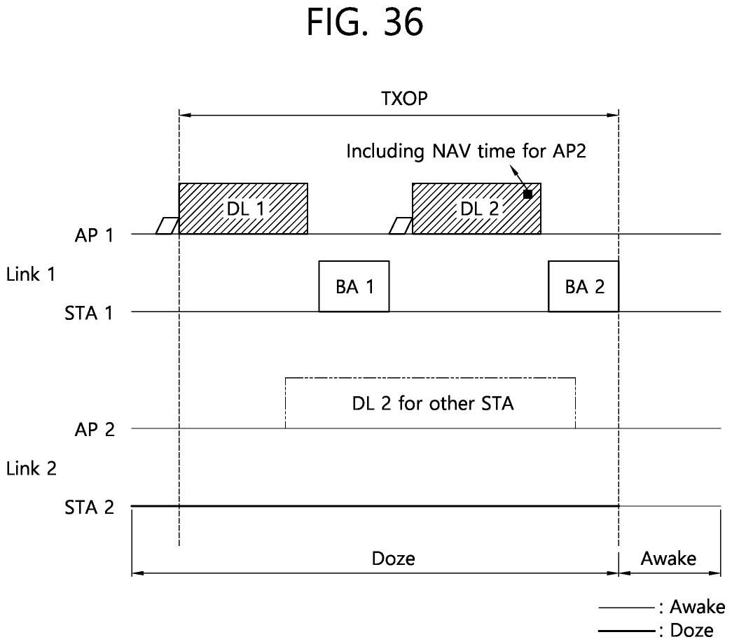

According to an embodiment, the NAV time (field/element) may be transmitted while being included in a DL frame to be transmitted to the STA through the link in the awake state. As another example, the NAV time (field/element) may be transmitted through a separate message through a link in an awake state. A specific operation related thereto may be described with reference to FIGS. 35 and 36.

FIG. 35 shows another example of the operation of a non-AP MLD and an AP MLD.

Referring to FIG. 35, when STA 2 is in a doze state, STA 2 may obtain NAV setting time information of the current AP 2 through a DL frame received by STA 1 in an awake state. For example, STA 1 of non-AP MLD may acquire NAV setting time information of AP 2 through a DL frame. The non-AP MLD may share (or transmit) NAV setting time information of AP 2 obtained from STA 1 with STA 2 based on an internal information sharing process.

For example, AP 1 may transmit NAV time information of AP 2 by including the NAV time field in a DL frame it transmits to STA 1. As an example, the NAV time information of AP 2 may include information about the remaining NAV time or the NAV end time.

In the example of FIG. 35, when STA 2 wakes up, since TXOP (or NAV) for another STA is set, STA 2 may operate based on the acquired NAV time information. In other words, when the state of the STA 2 is changed to the awake state, the AP 2 may be in a state in which the TXOP for the other STA is obtained. Accordingly, STA 2 may set the NAV based on the acquired NAV time information.

According to an embodiment, after STA 2 changes the state to the awake state, STA 2 may set the NAV based on the acquired NAV time information.

According to an embodiment, the STA 2 may maintain the doze state without changing to the awake state based on the acquired NAV time information.

FIG. 36 shows another example of the operation of a non-AP MLD and an AP MLD.

Referring to FIG. 36, when STA 2 is in a doze state, STA 2 may obtain NAV setting time information of the current AP 2 through a DL frame DL 2 received by STA 1 in an awake state.

Unlike FIG. 35, the NAV setting time of the AP 2 may end before the time when the STA 2 wakes up. In this case, AP 1 may transmit by setting the value of the NAV time field included in DL 2 to 0. Upon receiving this, STA 1 may share NAV time information with STA 2 through internal information sharing of the non-AP MLD.

STA 2 may know that there is no TXOP (or NAV) configured by AP 2 for other STAs at the time when STA 2 wakes up. Accordingly, STA 2 does not need to perform CCA until the probe delay expires.

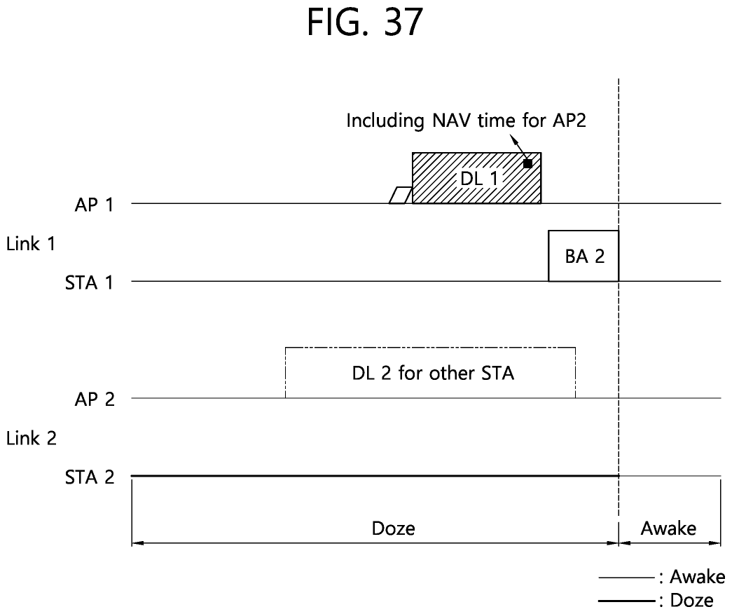

The NAV time information proposed in this specification may not be included in the DL transmitted by the AP, but may be transmitted in a separate frame as in the above-described embodiment. A specific operation related thereto may be described with reference to FIG. 37.

FIG. 37 shows another example of the operation of a non-AP MLD and an AP MLD.

Referring to FIG. 37, AP 1 may transmit a separate message to inform STA 2 of the updated NAV information of AP 2 instead of a DL frame transmitted to STA 1. A separate message may be used when there is no DL frame transmitted from AP 1 to STA 1. Since the DL frame can be transmitted regardless of whether the AP 1 transmits the DL frame, there is an effect that information can be more flexibly informed to the STA 2. However, frame overhead may occur.

In the present specification, it is assumed that STA 2 awakes according to the TXOP end time of STA 1, but the awake timing may be changed. In this case, the AP MLD may know that STA 2 operates as a power saving mechanism, and may also know information on when STA 2 wakes up.

According to the above-described embodiment, there is an effect of solving the limitation that the STA cannot share the updated NAV configuration information of the AP due to the existing power saving. In addition, according to the above-described embodiment, there is an effect that the scanning time of the STA waking in the doze state to detect the NAV of the connected AP can be reduced.

Hereinafter, operations of the multi-link device and the AP multi-link device for the above-described embodiments may be described.

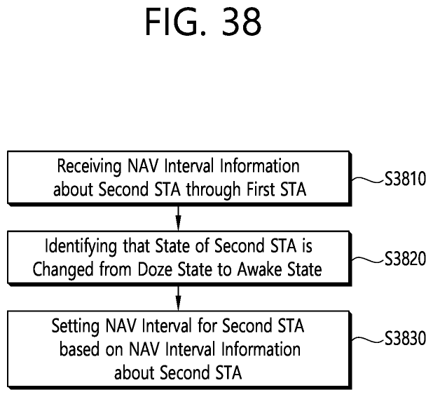

FIG. 38 is a flowchart for explaining the operation of a multi-link device.

Referring to FIG. 38, in step S3810, the multi-link device may receive NAV interval information about a second STA through a first STA.

For example, the multi-link device may be connected to the AP multi-link device through a first link and a second link. The multi-link device may include a first STA and a second STA. The first link and the second link may each be included in one of the 2.4 GHz, 5 GHz, and 6 GHz bands.

As an example, the first STA may be connected to the first link. In other words, the first STA may operate in the first link. Also, the first STA may be connected to the first AP of the AP multi-link device through the first link.

As an example, the second STA may be connected to the second link. In other words, the second STA may operate on the second link. In addition, the second STA may be connected to the second AP of the AP multi-link device through the second link.

According to an embodiment, the multi-link device may share (or transmit) NAV interval information about the second STA received through the first STA with the second STA through an internal information sharing process.

According to an embodiment, the NAV interval information about the second STA may include information on the remaining NAV time or information on the NAV end time. That is, the NAV interval information may include information for indicating the NAV interval to be set by the second STA. The second STA may check the end time of the NAV interval to be set based on the NAV interval information about the second STA.

According to an embodiment, NAV interval information about the second STA may be transmitted through various frames. For example, NAV interval information about the second STA may be included in a data frame transmitted through the first link. As another example, NAV interval information about the second STA may be transmitted through an independent frame.

According to an embodiment, when NAV interval information about the second STA is received, the second STA may operate in a doze state.

For example, the second STA may operate in a power save mode (PSM). When the second STA operates as a PSM, the second STA may operate in one of a doze state and an awake state based on a specified condition.

For example, the multi-link device may confirm that the TXOP period is set in the first link. In other words, the multi-link device (for example, the first STA) may confirm that the first AP has obtained the TXOP.

The multi-link device may set the second STA to a doze state during the TXOP period configured in the first link. For example, the multi-link device may change the state of the second STA from the awake state to the doze state based on the TXOP period configured in the first link. In addition, after the end of the TXOP period set in the first link, the state of the second STA may be changed from the doze state to the awake state. In other words, the multi-link device may change the state of the second STA from the doze state to the awake state after the end of the TXOP period set in the first link.

According to an embodiment, the multi-link device may receive information on whether or not to set the NAV for the second STA through the first STA. The multi-link device may determine whether NAV setting is required in the second STA, based on information on whether NAV setting for the second STA is required.

For example, information on whether to set the NAV for the second STA may be set as 1-bit information. Based on the information on whether or not to set the NAV for the second STA is a first value (for example, 1), the multi-link device (or the second STA) may set the NAV interval when the second STA changes to the awake state. Based on the information on whether to set the NAV for the second STA is a second value (for example, 0), the multi-link device (or the second STA) may not set the NAV interval when the second STA is changed to the awake state.

For example, information on whether to configure NAV for the second STA may be received together with NAV interval information about the second STA.

According to an embodiment, NAV interval information about the second STA may be transmitted together with a link identifier on the second STA. The link identifier for the second STA may include a link ID of the second link. The multi-link device may confirm that the NAV interval should be set in the second link based on the link identifier for the second STA.

In step S3820, the multi-link device may identify that the state of the second STA is changed from the doze state to the awake state. For example, after the end of the TXOP period established in the first link, the state of the second STA may be changed from the doze state to the awake state. As another example, power save mode (PSM) may be released in the second STA. Accordingly, the multi-link device may identify that the state of the second STA is changed from the doze state to the awake state.

In step S3830, the multi-link device may set the NAV interval for the second STA based on the NAV interval information about the second STA. The second STA may not perform CCA until the set NAV interval expires.

That is, when the second STA operates in a doze state, the multi-link device may receive NAV interval information about the second STA through the first STA. Thereafter, when the state of the second STA is changed from the doze state to the awake state, the multi-link device may set the NAV interval for the second STA based on the NAV interval information about the second STA.

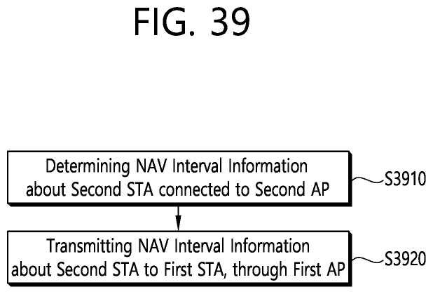

FIG. 39 is a flowchart for explaining the operation of an AP multi-link device.

Referring to FIG. 39, in step S3910, the AP multi-link device may determine NAV interval information about the second STA connected to the second AP operating in the second link.

For example, the AP multi-link device may be connected to the multi-link device through a first link and a second link. The AP multi-link device may include a first AP and a second AP. The first link and the second link may each be included in one of the 2.4 GHz, 5 GHz, and 6 GHz bands.

For example, the first AP may be connected to the first link. In other words, the first AP may operate in the first link. Also, the first AP may be connected to the first STA of the multi-link device through the first link.

For example, the second AP may be connected to the second link. In other words, the second AP may operate in the second link. In addition, the second AP may be connected to the second STA of the multi-link device through the second link.

For example, the AP multi-link device may confirm that data (or PPDU) is being transmitted from the second AP to other STAs except for the second STA. The AP multi-link device may determine NAV interval information about the second STA based on the interval in which the data is transmitted.

For another example, the AP multi-link device may confirm that the TXOP (or TXOP period) for transmitting data (or PPDU) from the second AP to another STA except for the second STA is obtained. The AP multi-link device may determine NAV interval information about the second STA based on the TXOP.

According to an embodiment, the NAV interval information about the second STA may include information on the remaining NAV time or information on the NAV end time. That is, the NAV interval information may include information for indicating the NAV interval to be set by the second STA.

In step S3920, the AP multi-link device may transmit NAV interval information about the second STA to the first STA through the first AP operating in the first link. For example, when NAV interval information about the second STA is received, the second STA may operate in a doze state.

According to an embodiment, NAV interval information about the second STA may be transmitted through various frames. For example, NAV interval information about the second STA may be included in a data frame transmitted through the first link. As another example, NAV interval information about the second STA may be transmitted through an independent frame.

According to an embodiment, the AP multi-link device may transmit information on whether or not to set the NAV for the second STA through the first AP. For example, the AP multi-link device may transmit information on whether or not to set the NAV for the second STA together with the NAV interval information for the second STA. Information on whether to set the NAV may be set as 1-bit information.

When the NAV setting is required in the second STA, information on whether to set the NAV may be set to a first value (for example, 1). When the NAV setting is not required in the second STA, information on whether to set the NAV may be set to a second value (for example, 0).

The technical features of the present disclosure described above may be applied to various devices and methods. For example, the above-described technical features of the present disclosure may be performed/supported through the apparatus of FIGS. 1 and/or 19. For example, the above-described technical features of the present disclosure may be applied only to a part of FIGS. 1 and/or 19. For example, the technical features of the present disclosure described above may be implemented based on the processing chips 114 and 124 of FIG. 1, may be implemented based on the processors 111 and 121 and the memories 112 and 122 of FIG. 1, or may be implemented based on the processor 610 and the memory 620 of FIG. 19. For example, the apparatus of the present disclosure includes a processor and a memory coupled to the processor. The processor may be adapted to receive, from an access point (AP) through a first STA operating in a first link, network allocation vector (NAV) interval information about a second STA operating in a second link, wherein, when the NAV interval information about the second STA is received, the second STA operates in a doze state; identify that the state of the second STA is changed from the doze state to an awake state; and set a NAV interval for the second STA, based on the NAV interval information about the second STA.

The technical features of the present disclosure may be implemented based on a computer readable medium (CRM). For example, a CRM proposed by the present disclosure may store instructions which perform operations including the steps of receiving, from an access point (AP) through a first STA operating in a first link, network allocation vector (NAV) interval information about a second STA operating in a second link, wherein, when the NAV interval information about the second STA is received, the second STA operates in a doze state; identifying that the state of the second STA is changed from the doze state to an awake state; and setting a NAV interval for the second STA, based on the NAV interval information about the second STA. The instructions stored in the CRM of the present disclosure may be executed by at least one processor. At least one processor related to CRM in the present disclosure may be the processors 111 and 121 or the processing chips 114 and 124 of FIG. 1, or the processor 610 of FIG. 19. Meanwhile, the CRM of the present disclosure may be the memories 112 and 122 of FIG. 1, the memory 620 of FIG. 19, or a separate external memory/storage medium/disk.

The foregoing technical features of this specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1-20. (canceled)

21. A method in a wireless local area network system, the method comprising:
receiving, by a multi-link device (MLD) including a first station (STA) operating on a first link and a second STA operating on a second link from an access point (AP), network allocation vector (NAV) interval information about the second STA through the first link,
wherein, when the NAV interval information about the second STA is received, the second STA operates in a doze state;
in response to receiving the NAV interval information about the second STA, identifying, by the MLD, that a state of the second STA is changed from the doze state to an awake state; and
setting, by the MLD, a NAV interval for the second STA, based on the NAV interval information about the second STA.

22. The method of claim 21,
wherein the NAV interval information about the second STA includes information on remaining NAV time or information on NAV end time.

23. The method of claim 21,
wherein the NAV interval information about the second STA is included in a data frame of a physical layer protocol data unit (PPDU) transmitted through the first link.

24. The method of claim 21, wherein the method further comprises,
receiving, by the MLD through the first STA, information on whether a network allocation vector (NAV) is set for the second STA.

25. The method of claim 21,
wherein the NAV interval information about the second STA is transmitted together with a link identifier for the second STA.

26. The method of claim 21,
wherein the second STA operates in a power save mode (PSM).

27. The method of claim 21, wherein the method comprises,
confirming, by the MLD, that a transmission opportunity (TXOP) interval is configured in the first link; and
setting, by the MLD, the second STA to the doze state during the TXOP interval configured in the first link.

28. The method of claim 27,
wherein, after end of the TXOP interval configured in the first link, the state of the second STA is changed from the doze state to the awake state.

29. The method of claim 21, wherein the method further comprises,
sharing, by the MLD with the second STA, the NAV interval information about the second STA received through the first STA, based on internal information sharing process of the MLD.

30. The method of claim 21,
wherein the first link and the second link are included in one of 2.4 GHz, 5 GHz, and 6 GHz bands, respectively.

31. A multi-link device (MLD) in a wireless local area network system, the MLD comprising:
a first station (STA) operating on a first link;
a second STA operating on a second link; and
a processor coupled to the first STA and the second STA, wherein the processor is adapted to,
receive, from an access point (AP) through the first link, network allocation vector (NAV) interval information about the second STA,
wherein, when the NAV interval information about the second STA is received, the second STA operates in a doze state;
in response to receiving the NAV interval information about the second STA, identify that a state of the second STA is changed from the doze state to an awake state; and
set a NAV interval for the second STA, based on the NAV interval information about the second STA.

32. The MLD of claim 31,
wherein the NAV interval information about the second STA includes information on remaining NAV time or information on NAV end time.

33. The MLD of claim 31,
wherein the NAV interval information about the second STA is included in a data frame of a physical layer protocol data unit (PPDU) transmitted through the first link.

34. The MLD of claim 31, wherein the processor is further adapted to:
receive, through the first STA, information on whether a network allocation vector (NAV) is set for the second STA.

35. The MLD of claim 31,
wherein the NAV interval information about the second STA is transmitted together with a link identifier for the second STA.

36. The MLD of claim 31, wherein the processor is further adapted to:
confirm that a transmission opportunity (TXOP) interval is configured in the first link; and
set the second STA to the doze state during the TXOP interval configured in the first link.
